(19) United States
(12) Patent Application Publication
(10) Pub. No.: US 2019/0123580 A1
(43) Pub. Date: Apr. 25, 2019

(54) MANAGEMENT OF A POWER-DISTRIBUTION SYSTEM

(71) Applicant: Sigora International Inc., San Leandro, CA (US)

(72) Inventors: Bogdan Andrei Bindea, Waynesboro, VA (US); Francis Xavier Bergh, Chicago, IL (US); Michael Chapman, Charlottesville, VA (US); Jean Huguens Sawardjnes, Waynesboro, VA (US)

(21) Appl. No.: 15/873,865

(22) Filed: Jan. 17, 2018

Related U.S. Application Data
(60) Provisional application No. 62/576,029, filed on Oct. 23, 2017.

(51) Int. Cl. H02J 13/00; G05B 13/02; H02J 3/14

(52) U.S. Cl. CPC H02J 13/0017; H02J 2003/007; H02J 3/14; G05B 13/026

(57) ABSTRACT

In one embodiment, a method includes receiving, for each smart meter in a first group of multiple smart meters connected to a power-distribution system, first information about energy contributions to the power-distribution system tracked by the smart meter and receiving, for each smart meter in a second group of the smart meters, second information about energy consumption from the power-distribution system tracked by the smart meter. The method also includes determining, based on the first information and the second information, a likelihood of an energy shortage during a specified period of time. The method further includes sending instructions to one or more of the smart meters in the second group to limit consumption of energy during the specified period of time and sending instructions to one or more of the smart meters in the first group to increase their energy contributions during the specified period of time.

### PRIORITY

This application claims the benefit, under 35 U.S.C. § 119(e), of U.S. Provisional Patent Application No. 62/576029, filed 23 Oct. 2017, which is incorporated herein by reference.

### TECHNICAL FIELD

This disclosure generally relates to management of a power-distribution system.

### BACKGROUND

An electrical grid is an interconnected network of infrastructure for delivering electricity among utility service providers and consumers. It may comprise generating stations that produce electrical power, high-voltage transmission lines that carry power from distant sources to demand centers, and distribution lines that connect individual customers. A distribution transformer may provide voltage transformation that steps down the voltage used in high-voltage transmission lines to the level useable by customers. The electric grid may also comprise a plurality of electric meters for measuring the amount of electric energy consumed by customers. Electricity may be transmitted within an electrical grid as single-phase, split-phase, or three-phase electric power. Single-phase electric power is commonly used by homes or other non-industrial premises. Three-phase electric power is commonly used for long-distance transmission and high-power systems. Triplex cables, which comprise three insulated conductor lines, are often used in electrical grids.

### SUMMARY OF PARTICULAR EMBODIMENTS

Particular embodiments provide a tiered anti-theft system comprising one or more layers corresponding to an active anti-theft system, a passive anti-theft system, a destructive anti-theft system, or a physical anti-theft system, respectively. Particular embodiments disclose a method and system for providing electrical network service or data content-distribution service based on the infrastructure of a power-distribution system. Particular embodiments provide a method and system for billing distributed energy and data transactions by customers. Particular embodiments provide methods for promoting efficient utility operations based on real-time transactions by third parties.

Further details of aspects, objects, and advantages of the invention are described below in the detailed description, drawings, and claims. Both the foregoing general description and the following detailed description are exemplary and explanatory, and are not intended to be limiting as to the scope of the invention. Particular embodiments may include all, some, or none of the components, elements, features, functions, operations, or steps of the embodiments disclosed above. The subject matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### BRIEF DESCRIPTION OF THE DRAWINGS

FIGS. 1A and 1B illustrate an example power-distribution system implementing example anti-theft functionalities according to particular embodiments.

FIG. 2 illustrates an example scrambled waveform in triplex cables according to particular embodiments.

FIGS. 3A-D and 4A-D illustrate example structure of electric meters according to particular embodiments.

FIG. 5A illustrated an example mesh network comprising a plurality of smart meters according to particular embodiments.

FIG. 5B illustrates example components of an example smart meter.

FIG. 6 illustrates an example method for actively preventing energy theft by encrypting electricity transmitted in a power line.

FIG. 7 illustrates an example method for recording and verifying decentralized energy transactions.

FIGS. 8A and 8B illustrate an example method for recording a transaction in a blockchain.

FIG. 9 illustrates an example computer system.

### DESCRIPTION OF EXAMPLE EMBODIMENTS

Particular embodiments provide a tiered anti-theft system comprising one or more layers corresponding to an active anti-theft system, a passive anti-theft system, a destructive anti-theft system, or a physical anti-theft system, respectively. Particular embodiments disclose a method and system for providing electrical network service or data content-distribution service based on the infrastructure of a power-distribution system. Particular embodiments provide a method and system for billing distributed energy and data transactions by customers. Particular embodiments provide methods for promoting efficient utility operations based on real-time transactions by third parties.

The security of electrical grids is important to the smooth operation and business success of utility service providers. Energy theft from power lines is a major threat to such security and is particularly common in regions where existing infrastructure offers poor power-line protection (e.g., where power lines are above- rather than under-ground) and where the legal regime is not sufficiently developed or enforced to deter such theft. It is estimated that 20-50% of all electric energy produced in some developing countries amounts to “non-technical losses,” stolen from power lines and delivered to customers bypassing the utility's billing system. Energy theft makes grid operations cost prohibitive for utility service providers to reach potential customers in frontier markets with affordably-priced electricity service.

Particular embodiments disclosed herein are directed to solving the problem of energy theft from power lines as well as affordable electricity service in frontier markets. Particular embodiments focus on theft of electricity from the portion of the power line between the secondary side of a distribution transformer and an electric meter associated with a customer, which measures the customer's energy consumption. This portion may be called a “hot zone,” within which energy users can bypass electrical meters to steal electricity that is still in the distribution system but operating a voltage that is suitable for utilizations. In particular situations, power lines within the hot zone may hang overhead on utility poles. In most developing countries, locating electrical distribution underground may be 4-10× more expensive than overhead, depending on soil type and topography.

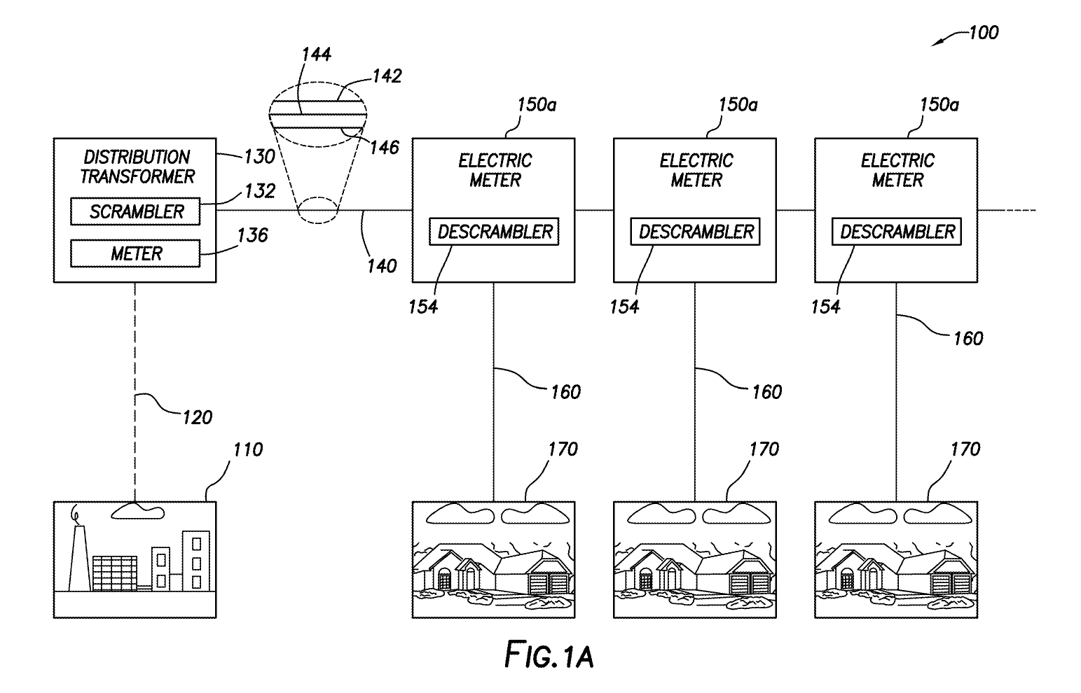

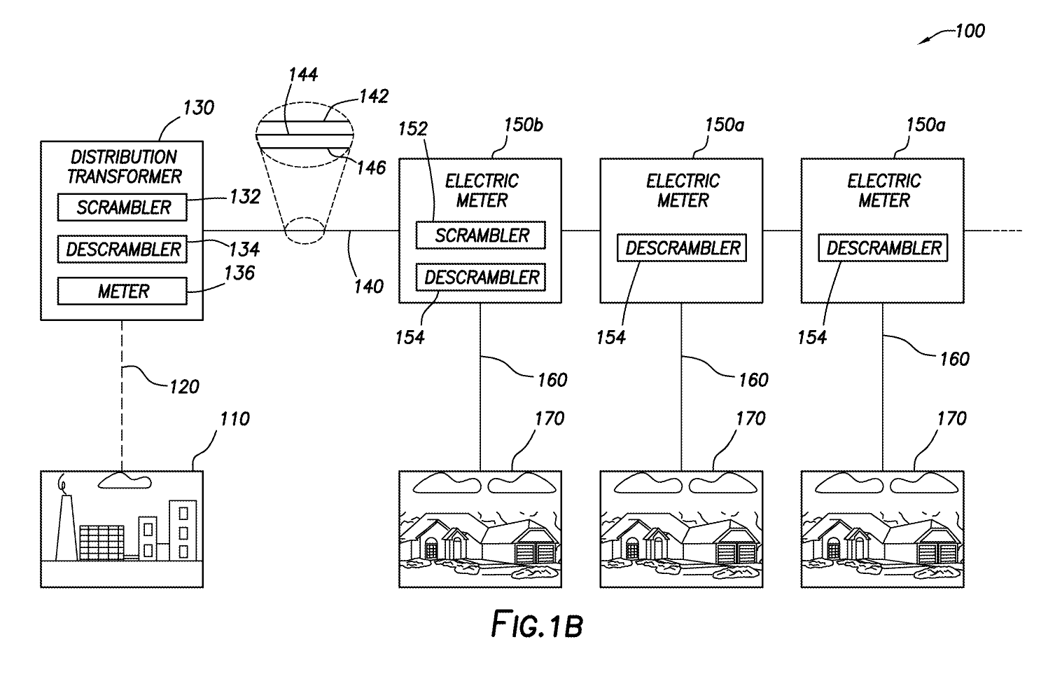

FIGS. 1A and 1B illustrate an example power-distribution system 100 implementing example anti-theft functionalities according to particular embodiments. In particular embodiments, electricity transmitted in the power lines may be encrypted to prevent usage by unauthorized individuals. The encryption may be carried out within the hot zone between the secondary side of a distribution transformer 130 and one or more meters 150 associated with one or more customers. The distribution transformer 130 may receive electricity generated by a generating station 110 via electrical grid 120. The meters 150 may provide power supply to one or more customer premises 170 via main service lines 160, while measuring and recording the amount of electric energy consumed by each of the customer premises 170. In particular embodiments, the distribution line 140 between the distribution transformer 130 and the electric meters 150 may comprise two cables corresponding to an AC line and a neutral line, respectively. In particular embodiments, the distribution line 140 between the distribution transformer 130 and the electric meters 150 may comprise triplex cables comprising three conductor lines that may be named line-1 142, line-2 144, and neutral line 146.

In particular embodiments, as illustrated in FIG. 1A, the power-distribution system 100 may comprise a scrambler 132 that is located at the secondary side of the distribution transformer 130. Each meter 150a may comprise a descrambler 154. The scrambler 132 and descrambler 154 may each comprise a switch that flips between a connection point with line-1 142 and a connection point with line-2 144. The switches may be electric switches or relays based on insulated-gate bipolar transistors (IGBT), other types of transistors, or other suitable electronic devices. The switches may be driven by an electric signal that serves as an encryption key.

In particular embodiments, the distribution transformer 130 may output a single-phase waveform and feed such waveform to the scrambler 132. The switch associated with scrambler 132 may scramble the waveform by flipping between line-1 142 and line-2 144 over regular, irregular, or randomized time intervals to distribute the waveform between line-1 142 and line-2 144. The scrambled waveform may then be descrambled by the descramblers 154 located at the meters 150a and used by customers. The descramblers 154 may restore the electricity to a continuous waveform usable by customers. The neutral line 146 will be passed through the distribution network and into the customer premises 170 without being modified by the scrambler 132 or descrambler 154.

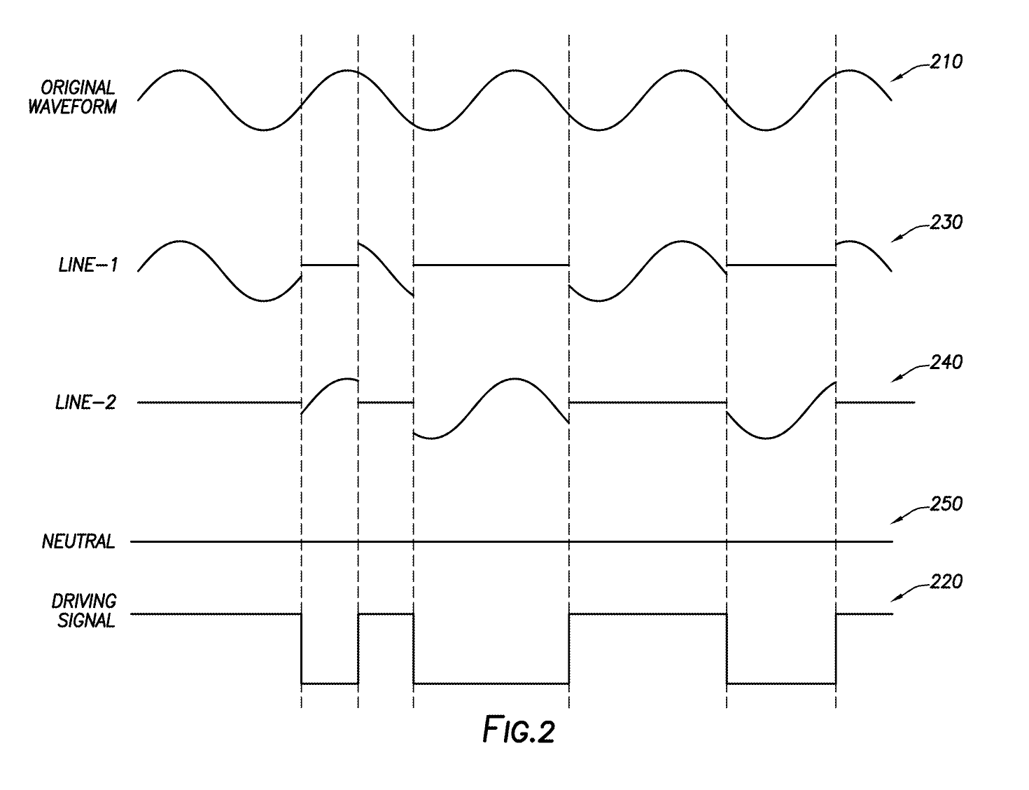

FIG. 2 illustrates an example scrambled waveform in triplex cables according to particular embodiments. In particular embodiments, the distribution transformer 130 may output a single-phase waveform 210 to the scrambler 132. The scrambler 132 may then allocate the waveform 210 between line-1 142 and line-2 over intermittent time intervals. The distribution may be based on a driving signal 220. The driving signal 220 may be an analog signal or a digital signal. The driving signal 220 may oscillate between two magnitudes or two ranges of magnitude. The oscillation may have a constant frequency. Alternatively, the oscillation may be randomized. In particular embodiments, the oscillation is envisioned to be significantly lower than the grid operational frequency (50-60 Hz depending on regional standards), but fast enough that power switches too rapidly for appliances to power up without descrambling the waveform (approximately 0.5-5.0 Hz, either constant or random).

As an example and not by way of limitation, the driving signal 220 may fluctuate between a high voltage and a low voltage in a randomized manner. The scrambler 132 may distribute the waveform 210 to line-1 142 when the signal 220 is at the high voltage and distribute the waveform 210 to line-2 144 when the signal 220 is at the low voltage. Each power line may carry no electric waveform during periods when the scrambler 132 distributes the input waveform to the other line. The scrambler 132 may thereby create the waveform 230 in line-1 142 and the waveform 240 in line-2 144. The waveform 250 in the neutral line 146 may remain neutral.

In particular embodiments, by dynamically allocating a continuous waveform 210 between line-1 142 and line-2 144, the power-distribution system 100 may prevent an unauthorized individual (e.g., an individual without access to the signal 220) from using the energy transmitted in the power lines. As an example and not by way of limitation, an unauthorized individual may connect a load between neutral 146 and either of line-1 142 and line-2 144 to steal energy. The load may range from small electronic devices (e.g., laptop computers, cell phones, tablets), office appliances (e.g., printers, monitors, facsimile machine), home appliances (e.g., lamps, refrigerator, microwave oven, television), industrial equipment, or other suitable load that may be powered by electricity distributed by the power-distribution system 100. Connected this way, the load may only receive the portion of the waveform 210 that is distributed over one of the power lines, which is scattered over fragmented time periods.

In particular embodiments, the scrambled waveform may fluctuate between a normal AC voltage and a zero voltage at a high frequency. Particular electronic devices may only function properly or efficiently when the power supply voltage is within a particular range. Such devices may not be required by relevant utility or product certification standards (e.g., UL, IEC, ANSI, IEEE, CE) to function outside the voltage range. The continuously interrupted power supply caused by power-scrambling may prevent particular devices (e.g., certain inductive-motor-driven devices like refrigerators and pumps) from functioning at all. It may cause particular devices to function in undesirable ways (e.g., causing light bulbs to blink). It may also cause particular devices to function substantially less efficiently (e.g., causing a phone charger to charge slowly). However, this operational mode is unlikely to cause destructive, hazardous, or unsafe conditions within the devices. In particular embodiments, the frequency with which the scrambler switches between line-1 142 and line-2 144 may be set to be sufficiently high such that the power supply only drives inrush current in a load associated with an unauthorized individual. In particular embodiments, the average time period between each two consecutive switching instances may be a fraction of a second or any suitable length of time. As an example and not by way of limitation, the oscillation frequency may be significantly lower than the grid operational frequency (50-60 Hz depending on regional standards), but fast enough that power switches too rapidly for appliances to reach steady-state energization without descrambling the waveform. Therefore, the optimal scrambling frequency may be approximately 0.5-5.0 Hz, either constant or random. In particular embodiments, the scrambler may balance the energy allocation for each line, such that the total time that each line is powered is the same or similar.

Particular embodiments as described above provides a novel and cost-effective solution for encrypting single-phase electricity transmitted in the hot zone of a distribution line 140 and preventing an unauthorized user from using the unmetered energy therein. In particular embodiments, encrypting electric energy by switching between two power lines may be less costly than encrypting by modifying characteristics (e.g. voltage, frequency, AC/DC) of the electric energy being distributed in the lines.

In particular embodiments, the descrambler 154 may descramble the scrambled electricity in the distribution line 140. In particular embodiments, the encryption key is shared between the scrambler 132 and the descrambler 154. The encryption key may be pre-programed in both the scrambler 132 and the descrambler 154. Alternatively, the scrambler 132 and descrambler 154 may communicate over a wired or wireless network, via which the encryption key may be sent to the descrambler 154 in analog, digital, or another suitable format.

In particular embodiments, where the switching between the wires 142 and 144 by the scrambler 132 is performed with a constant frequency, the only necessary information to be shared between the scrambler 132 and the descrambler 154 may be (a) the frequency or period of the repetitive switching and (b) whether the switching begins on line-1 142 or line-2 144. The electric switch associated with the descrambler 154 may descramble the electric power by switching between connection points for line-1 142 and line-2 144 at the same frequency as the scrambler 132. In this way, the descrambler 154 may connect a main service line 160 always with an input that carries a non-zero waveform at the moment, thus restoring the waveform 210 in the main service lines 160. In particular embodiments, where the scrambler 132 scrambles the electricity in the distribution line 140 in an irregular or randomized manner, an encryption key may be shared between the scrambler 132 and the descrambler 154. The scrambler 154 may switch the connection to the main service line 160 between line-1 142 and line-2 144 according to the encryption key and with a proper temporal delay from the switching at the scrambler 132. The encryption key may be pre-programmed at the scrambler 132 and descrambler 154 or be synchronized at the scrambler 132 and descrambler 154 in real time via a wired or wireless network.

In particular embodiments, the power-distribution system 100 may allow one or more customers to locally generate power at customer premises 170. The power-distribution system 100 may allow and facilitate net-metering. Energy generated by interconnected customers may be sold to the generating station 110, distribution system operator, or one or more other customer premises 170. Such energy may similarly be encrypted to prevent theft. As illustrated in FIG. 1B, each of one or more customer premises 170 may be equipped with an electric meter 150b, which may include a scrambler 152 to encrypt the power generated by the customer associated with the meter 150b. When net-metering is enabled, a descrambler 134 may be implemented or activated at the distribution transformer 130. The scrambled energy may be descrambled by the descrambler 134. It may also be descrambled by a descrambler 154 located at a meter 150a or 150b associated with another customer. The scrambler 152 may be structured and configured to function in a manner similar to the scrambler 132. The descrambler 134 may be structured and configured to function in a manner similar to the descrambler 154. In particular embodiments, the scrambler 132 and descrambler 134 may be implemented as a single device. The scrambler 152 and descrambler 154 may be implemented as a single device.

In particular embodiments, the anti-theft method and system described above makes energy theft by an unauthorized individual extremely difficult. The unauthorized individual must have access to the pattern of switching between line-1 142 and line-2 144 (in terms of a particular frequency or an irregular or randomized waveform) in order to descramble and use the energy. This is especially true in scenarios where an encryption key is used for the scrambling and descrambling of the electricity transmitted in the hot zone. Even if an unauthorized individual was able to steal an electric meter 150 and remove the descrambler 154 therein, the removed descrambler 154 would not have access to the encryption key since it is no longer connected to the wired or wireless network over which the encryption key is communicated. The network may be protected by multi-layer encryption and password-protection (e.g., according to standards such as NERC OP or US Department of Homeland Security requirements, for example). A secure login may be required to access any customer information, which may include information related to the energy encryption. Without such information, the unauthorized individual would not be able to obtain the encryption key and get access to descrambled electricity.

In particular embodiments, the power-distribution system 100 may comprise a tiered anti-theft system. The tiered anti-theft system may comprise one or more different tiers. Each tier may be implemented or deployed independently of the other tiers or in combination with one or more other tiers. The anti-theft system may comprise a layer corresponding to an active anti-theft system according to one or more embodiments disclosed above. The tiered anti-theft system may further comprise a layer corresponding to a passive anti-theft system. In particular embodiments, the electric meters 150 may be equipped with signal transmission and processing devices allowing them to communicate with each other and with a control center associated with the utility service provider either via fixed access points or a mesh wireless communications protocol, which may be standard or proprietary.

In particular embodiments, one or more electric meters 136 (e.g., a main/check meter pair) may be implemented at the secondary side of the distribution transformer 130 for measuring various characteristics (e.g., current, voltage, power, power factor, energy, frequency) of the input or output electricity at the distribution transformer 130. In particular embodiments, an electric meter 136 may operate at three-phase 480 volts (“V”), at split-phase 240 V, or at residential voltage 120 V. The electric meter 136 may be configured to allow a higher amount of current to pass through than that allowed by customer meters 150, which are designed for, for example, 15 amperes (“A”). The electric meter 136 may use a current transformer (“CT”) rather than the shunt resistor method, which is often used in residential electric meters 150. This may allow the electric meter 136 to measure power at a higher degree of precision. The electric meter 136 may comprise any other suitable electric meters.

In particular embodiments, one or more customer meters 150, one or more meters 136 located at the distribution transformer 130, and one or more meters located at the generating station 110 may each report its measurements to the control center in real time. Based on the reports, an administrator of the power-distribution system 100 may monitor the total amount of energy generated by the generating station 110, the amount of energy transmitted to each distribution transformer 130, and the amount of energy used by each customer premise 170. The administrator may then determine if there is any discrepancy among the reported values. The determination may be performed by software embodied on computer systems at the control center. As an example and not by way of limitation, a total amount of energy consumed by all customer premises 170 powered by a particular distribution transformer 130 may be compared with a total amount of energy transmitted through the distribution transformer 130, which can be separately metered by the electric meter 136. If the former is smaller than the latter by an amount that substantially exceeds a normal level of energy loss over transmission, a discrepancy may be detected. The administrator may thereby determine that energy is being stolen from the distribution line 140. In particular embodiments, field workers may be dispatched to corresponding areas to investigate the issue. One investigative method may comprise temporarily shutting off power for all paying customers supported by the identified distribution transformer 130 to isolate any portion of the distribution line 140 compromised by energy theft. This will facilitate theft detection because if a local circuit is switched off during nighttime hours, any house with its lights on or electrical equipment running can be assumed to be stealing power and easily identified. Similar methods can also be used during daytime hours. This integrated performance of electric meters at distribution transformers and customer premises can greatly simplify theft detection and enforcement on distribution networks with or without active anti-theft systems. These products and services can be highly relevant to electric utilities seeking to address non-technical losses and energy theft, but will not require triplex retrofits to electrical distribution lines and service drops.

Particular embodiments of the passive anti-theft system take advantage of smart meters' communication capabilities to provide a tool for effectively detecting energy theft. The functioning of the passive anti-theft may not be disrupted even if an energy thief is savvy enough to descramble electric power encrypted according to particular embodiments of the active anti-theft system, which, as discussed above, is very difficult.

In order to descramble power from an active anti-theft network, the intruder would need to detect: the frequency, whether the frequency is fixed or variable, the initial state (i.e. which line is “hot”) of the waveform at the time of initial synchronization. The intruder would also need to have a device capable of switching between the active power lines, which requires specialized electronic equipment. Each of these variables adds to the layered security of the active anti-theft network.

In particular embodiments, the tiered anti-theft system may comprise a layer corresponding to a destructive anti-theft system. Each meter 150 may comprise a controller corresponding to the destructive anti-theft system. An active mode of the destructive anti-theft system may be triggered at a time determined by an administrator of the power-distribution system 100. When the active mode is triggered, the controllers associated with the meters 150 may be instructed to temporarily shut off the power supply to the main service lines 160. Shortly afterwards, the distribution lines 140 may be fed with a source of a voltage that is significantly greater than the normal end-user supply voltage. As an example and not by way of limitation, the power-distribution system 100 may normally provide electricity of 120 V to its customers. After the controllers disconnect customer premises 170 from the power-distribution system 100, a power source of significantly higher voltage (e.g., 240 V, 480 V) may be fed to the distribution line 140. At this time, while all customer premises 170 are disconnected and protected from the high-voltage pulse, any unauthorized load connected to the distribution line 140 may be directly exposed to the heightened voltage. The over-voltage may cause damage to any unauthorized load and deter future energy theft.

In particular embodiments, the tiered anti-theft system may comprise a layer corresponding to a physical anti-theft system. One typical setup of power lines may comprise hanging electric cables on utility poles and suspending the wires over the area between poles. The setup may also comprise installing an electric meter in the vicinity of a customer premise (e.g., on a wall of a building). A wire may drop from the power lines and connect to the electric meter. This type of setup may allow relatively easy access to the hot zone at ground level and manipulation of the cables by an energy thief. Particular embodiments disclosed herein may prevent manipulation of wires connecting the electric meters to the electrical grid by modifying the physical locations of meter installation.

In particular embodiments, an electric meter 150 may be implemented as a clamp-on attachment that hangs from suspended power distribution lines 140. This arrangement reduces the size of the hot zone and relocates the meters 150 high enough to be difficult for unauthorized individuals to reach safely and inconspicuously. It also makes any attempt to temper with the portion of the power line between the distribution transformer 130 and the electric meters 150 easier to detect, thereby deterring criminal activity.

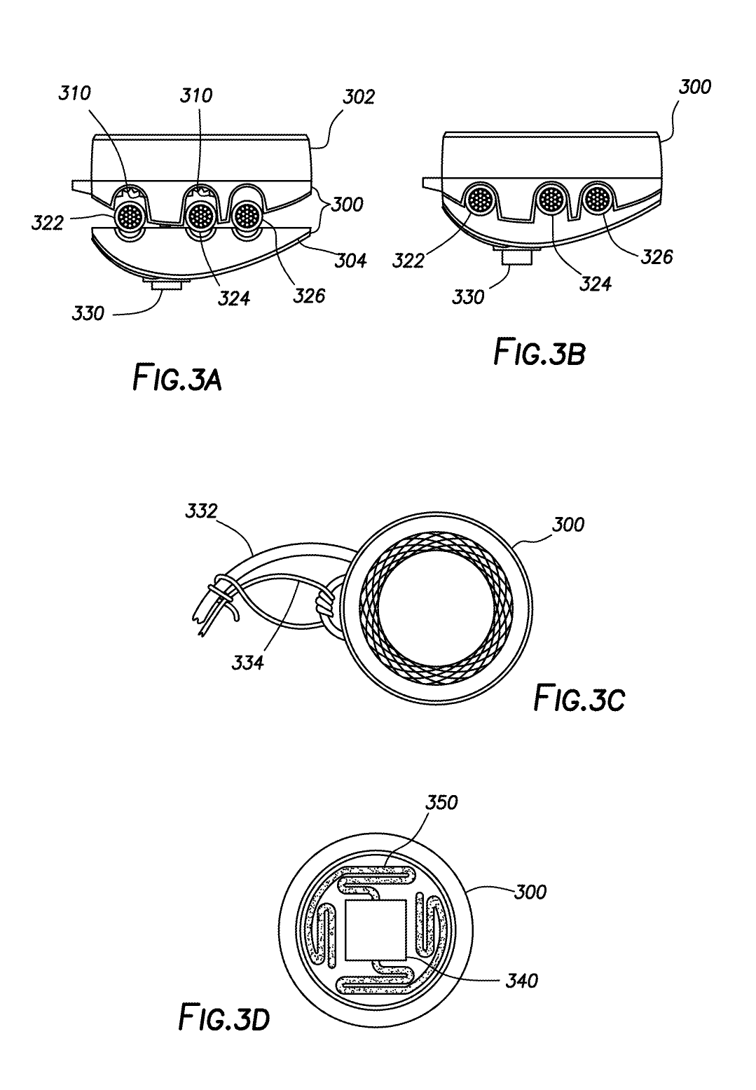

FIGS. 3A-D and 4A-D illustrate example structure of the electric meters according to particular embodiments. FIGS. 3A and 3B illustrate side view of an example clamp-on meter 300. The meter 300 may comprise two opposing plates (or jaws) 302 and 304 and two sets of insulation-piercing connectors (or teeth) 310. Each of the two insulation-piercing connectors 310 may have two or more sets of teeth, offering redundant and more secure electrical and mechanical connections—one on each side of the clamp on meter enclosure. Each of the opposing plates 302 and 304 may have one or more grooves on its inner surface. The insulation-piercing connectors 310 may be fixed to the opposing plates 302 and 304 and be positioned within the grooves. The separation or gap between the jaws 302 and 304 may be adjustable. Specifically, the jaws are in an open position in FIG. 3A and a closed position in FIG. 3B. As illustrated by FIG. 3B, when the adjustable gap between the opposing plates 302 and 304 is closed, one or more grooves on one of the opposing plates may align with one or more grooves on the other opposing plate to form one or more channels. One or more electric wires may be contained in the channels. In particular embodiments, the clamp-on meter 300 may be positioned to contain the three wires of a triplex cable (e.g., including line-1 322, line-2 324, and neutral line 326) in its channels. In particular embodiments, the wire for line-1 322 and line-2 324 may each be covered by insulating materials and the conductor wire for the neutral line 326 may be exposed. The three wires may normally be bundled together and wrapped by an outer sheathing made of insulating materials. The outer sheathing may be first stripped in order to clamp the meter 300 on the wires. The jaws 302 and 304 may then be closed. The two sets of insulation-piercing connectors 310 may pierce through insulators on each of the two non-neutral wires to establish metal-to-metal mechanical and electrical connections between them sufficient for the distribution of electrical energy in a manner consistent with the grid code and safety requirements. The insulation-piercing connectors (teeth) 310 may reduce the time, cost, and complexity of meter installation, especially for installations conducted using a bucket-truck from the roadway.

The clamp-on meter 300 may also have a main service line connector 330. As illustrated in FIGS. 3C and 3D, which illustrate top view of the clamp-on meter 300, the connector 330 may be connected with a main service line 332 that provides power supply to a customer premise 170. The main service line 332 may be aligned with and mechanically supported by a steel messenger cable 334, providing strain relief for the electrical and mechanical connections. The messenger cable 334 may be made of any other suitable material. The clamp-on meter 300 may further comprise a circuit board 340 (e.g., a single-board computer and metering circuit) for processing and storing data (e.g., measurement data, network data, transaction data) and an antenna 350 for transmitting and receiving radio-frequency (RF), Wi-Fi, or other suitable wireless signals. The circuit board 340 may support one or more communication interfaces with one or more other systems. The circuit board 340 and antenna 350 may be attached to either of the opposing plates or jaws 302 and 304 or embedded within a lid of the clamp-on meter 300. In particular embodiments, the clamp-on meter may comprise a suitable display device (e.g., LCD display). Alternatively, the clamp-on meter may not have any LCD display screen due to its positioning far from eye level. In particular embodiments, the onboard circuitry may wirelessly communicate metering data and status in real-time to the distribution system data network, allowing customer to access their current balance data via web browser, mobile app, SMS/email text-based interface, or other suitable methods. This may enable a customer-friendly customer information database more appropriate for pre-paid electric service in frontier markets than systems which require data to be read and recorded manually.

FIG. 4A and FIG. 4B illustrate side view of an example multi-customer clamp-on meter 400. The meter 400 may comprise two opposing plates (or jaws) 402 and 404 and two sets of insulation-piercing connectors (or teeth) 410. Each of the opposing plates 402 and 404 may have one or more grooves on its inner surface. The insulation-piercing connectors 410 may be fixed to the opposing plates 402 and 404 and be positioned within the grooves. The separation or gap between the jaws 402 and 404 may be adjustable. Specifically, the jaws are in an open position in FIG. 4A and a closed position in FIG. 4B. As illustrated by FIG. 4B, when the adjustable gap between the opposing plates 402 and 404 is closed, one or more grooves on one of the opposing plates may align with one or more grooves on the other opposing plate to form one or more channels. One or more electric wires may be entrapped or contained in the channels. For an example triplex cable, the two non-neutral wires 322 and 324 may be run through the channels on the clamp-on meter 400. The jaws 402 and 404 may then be tightened to clip on the wires 322 and 324. The insulation-piercing connectors 410 may pierce through insulators on each of the wires 322 and 324 and establish mechanical and electrical connections with them. The neutral wire 326 may pass over the bottom of the jaw 404, such that the clamp-on meter 400 sits on the uninsulated neutral wire 326.

In particular embodiments, the clamp-on meter 300 may be configured such that one or more of its components are conveniently installable and removable. The components may comprise one or more metering components, one or more computing devices (or circuit boards), one or more antennas, one or more other suitable components, or any combination thereof. In particular embodiments, one or both of the opposing plates 302 and 304 may comprise a container. The container may comprise one or more ports that are configured to interface with one or more components (e.g., electric meters, computing devices, antennas). The components may be connected to or removed from the ports. As the ports may be connected with one or more of the insulation-piercing connectors 310, the components (e.g., an electric meter) may receive an input from the insulation-piercing connectors 310 through the ports. The opposing plates 302 and 304 may thereby serve as a “shell” for the inner components. While the opposing plates 302 and 304 may be fixed on a power line, the components can be conveniently installed, removed, or switched.

In particular embodiments, the clamp-on meter 400 may support more than one customer. As illustrated in FIG. 4C and FIG. 4D, which illustrate top view of the clamp-on meter 400, the meter 400 may be connected with two main service lines 432, each being mechanically supported by a messenger cable 434. The main service lines 432 may each provide power supply to a customer premise, whose energy consumption is separately metered, but jointly transmitted by common wireless network infrastructure, including but not limited to WiFi and/or RF antennae. In particular embodiments, a clamp-on meter may be structured to separately support and meter any suitable number of main service lines 160. The clamp-on meter 400 may further comprise a circuit board 440 (e.g., a single-board computer) for processing and storing data (e.g., measurement data, network data, transaction data) and an antenna 450 for transmitting and receiving wireless signals. The circuit board 440 and antenna 450 may be attached to either of the opposing plates or jaws 402 and 404 or embedded within a lid of the clamp-on meter 400.

Clamp-on meters according to particular embodiments provide an option for a technician to efficiently and cost-effectively add new customers to the power-distribution system 100. The clamp-on meters may also offer the capability of having mid-span tapping on electric distribution cables 140 suspended between utility poles. In particular embodiments, the meters 300 or 400 may clamp-on any suitable portion of an electric cable suspended between two poles. The electric cable may provide sufficient mechanical support for the weight of the meters without requiring proximity to a pole. Multiple meters 300 or 400 may clamp on an electric cable suspended between two poles. Particular embodiments may thereby obviate the need to erect a pole in proximity to each customer premise 170 to support an electric meter 150 or a main service line 160. Rather, the main service line 160 may directly drop from a clamp-on meter 150 that sits on the distribution line 140 via mechanical, electrical, and structural connection to the meter enclosure itself.

In particular embodiments, the wire used as the main service line 160 may be designed to facilitate mid-span tapping. A regular wire may not be sturdy enough to be attached to and dropped directly from a suspended cable. Gravity and environmental disturbance (e.g., wind) may cause stress and erosion to the wire to cause damages or unnecessary aging. In particular embodiments, an electric wire may be improved with additional mechanical support to fit particular use cases disclosed herein. As an example and not by way of limitation, an electric wire may be aligned with a messenger cable (e.g., made in steel or another suitable sturdy material). The electric wire and the messenger cable may be wrapped by insulating materials together to form an aggregate cable. For example, for a triplex wire in particular, each of the two wires with a non-zero voltage may be wrapped with an insulator. They may be aligned with the neutral wire and bundled within a common insulator. The bundled conductor wires may then be aligned with and attached to the messenger cable. The messenger cable would absorb the mechanical stress and protect the triplex wire from strain, fatigue, or deformation.

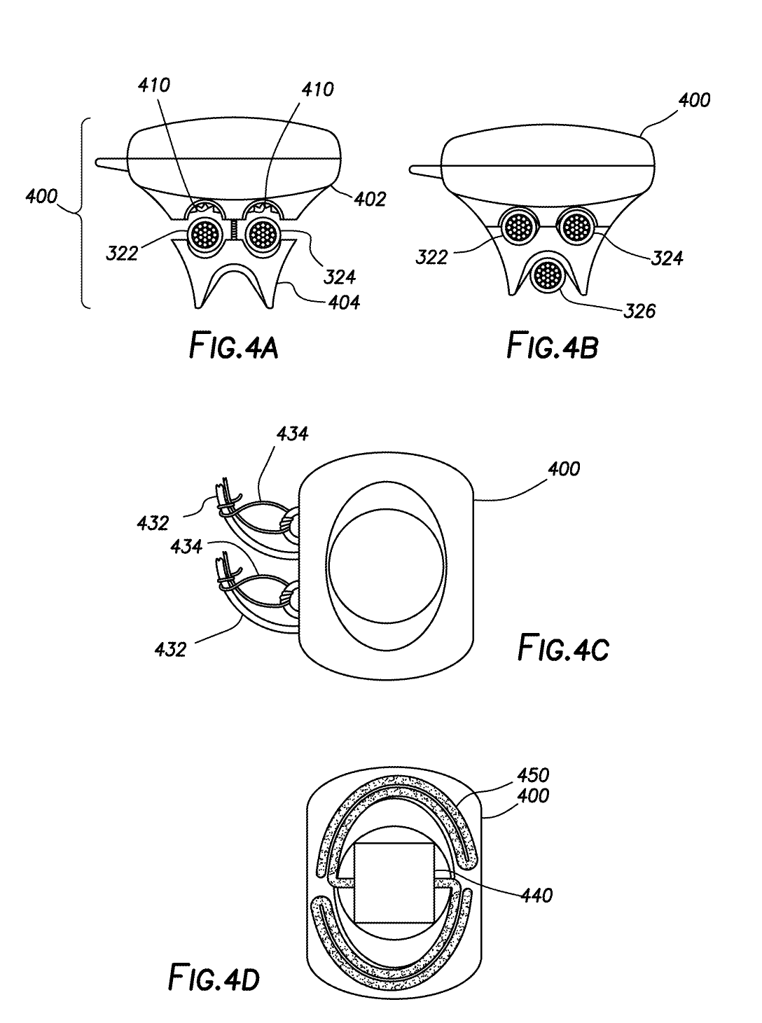

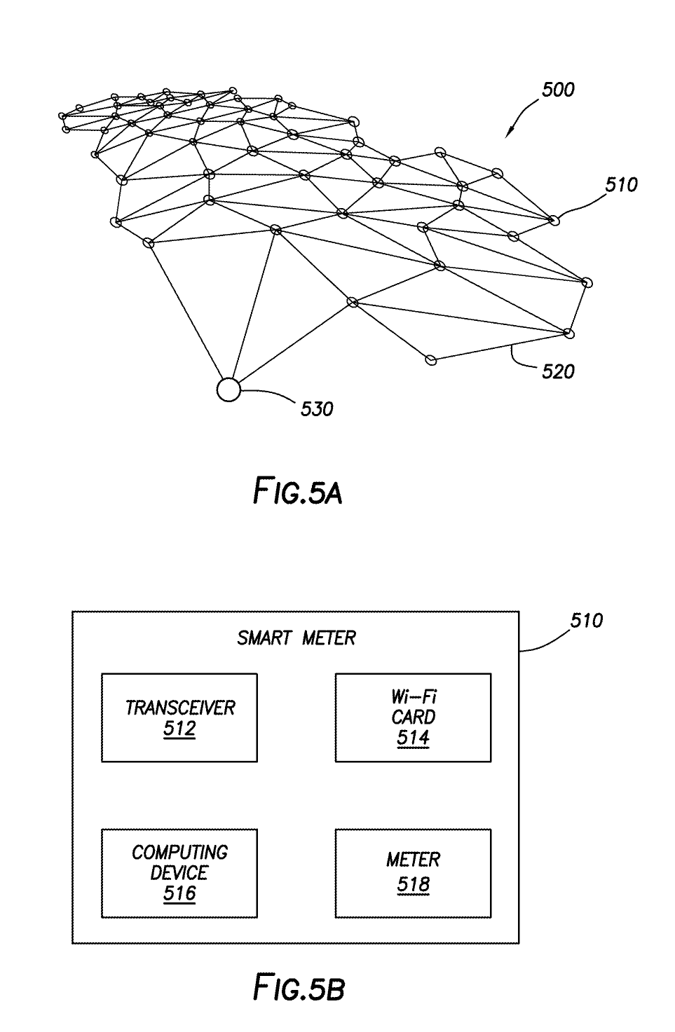

In particular embodiments, the electric meters in the power-distribution system 100 may be smart meters that are used not only to measure and record power consumption by the customers, but also to provision one or more additional products or services to the customers. FIG. 5A illustrated an example mesh network comprising a plurality of smart meters according to particular embodiments. In particular embodiments, a plurality of smart meters 510 within a particular region may communicate with one another via one or more wired or wireless media 520. The meters 510 may serve as nodes and together form a mesh network 500. The mesh network 500 may further comprise a node 530 corresponding to a control center associated with the utility service provider. The control center node 530 may be connected with one or more smart meters 510 via the media 520. To the extent that each node in the system has embedded computational hardware, e.g. a single board computer, individual nodes 510 may share or substitute computational roles assigned to a control center node 530.

FIG. 5B illustrates example components of an example smart meter 510. In particular embodiments, a smart meter 510 may be functional to communicate with one or more other devices using wired or wireless signals. The smart meter 510 may comprise a transceiver 512 that may be connected with a radio antenna or a Wi-Fi card 514 configured to manage Wi-Fi signals. The smart meter 510 may also comprise a computing device 516 that may comprise a processor and storage media. The computing device 516 may comprise a single-board computer, a fixed-function integrated circuit, or one or more other suitable controller devices. The smart meter 510 may further comprise one or more electric meters 518 for measuring the properties of electricity provided to a customer (e.g., voltage, frequency, current, power, power factor, energy). The smart meter 510 may provide automated or manual demand response, offering distributed voltage or frequency regulation based on the measurements to the grid operator. Demand response, or Demand Side Management (DSM), may be implemented in one or more smart meters 510. This may be achieved “manually,” by selecting a particular customer and a particular load limitation threshold, for example when configuring an individual account. Or it may be achieved in an automated fashion, for example implementing a particular tariff scheme across an entire group of customers. During generation shortfall events or emergency conditions, a grid operator may choose to implement DSM or automatic demand response (ADR) across an entire customer group, rather than just any one individual customer. These DSM, ADR, and load shedding activities may also be pre-programmed to occur in the grid, for example, when the batteries fall below 10% state of charge, or other external conditions occur, regardless of whether there is a utility technician monitoring the situation for manual DSM. In particular embodiments, each component of the smart meter 510 may be independently removable to facilitate expedient troubleshooting, calibration, reprogramming, cost reduction, and maintenance.

In particular embodiments, the smart meters 510 may provide network service to customers. With Wi-Fi and RF capabilities, each smart meter 510 may serve as a network hotspot. Together, the smart meters 510 may form a wireless local area network or wide area network. Each user may be assigned an account and be connected to the network using corresponding account information. The network account may be linked to a user's account for utility billing purposes. In particular embodiments, a user may access the wireless network whenever the user has a valid account and the user's client device is within the transmission range of any smart meter 510 that serves as a Wi-Fi hotspot or any other network infrastructure serving as a Wi-Fi hotspot. The wireless network may be used to deliver content to users. The content may comprise, for example, local news, information associated with the utility service provider, information about a customer's utility usage, commercial (advertising) material for the utility service provider or other third parties, or other suitable content. In particular embodiments, one or more nodes 510 of the mesh network 500 may be connected to a wired or cellular access point to the internet. Personal devices connected to the mesh network 500 may then obtain access to content on the internet regardless of where they are physically located within the network. The digital content may be distributed free of charge, on a fixed subscription rate, on a pay-per-use basis, or any combination of tiered billing mechanisms. The content may be accessed on a real-time basis, such as a web browsing, or locally hosted materials, such as locally hosted music and videos.

In particular embodiments, the electric wires may serve as power-line carrier for network signals. The power-line carrier (PLC) may be more cost-efficient than a wireless carrier in particular situations, especially over long distances. Transformers in an electrical grid may impede the transmission of network signals. To address this issue, wave traffic may be temporarily diverted from the power line and returned to the power line to circumvent a transformer. In particular embodiments, a scrambler 132 or 152 may scramble the signal waveform as between two power wires and a descrambler 134 or 154 may descramble the waveform and provide it to a receiver. Noise reduction techniques may be used to reduce the noise introduced by the scrambling and descrambling. In some embodiments, communications may be simultaneously and redundantly managed via Wi-Fi, RF, fiber-optic (hard-wired), and PLC to boost network robustness, reliability, and resiliency in frontier markets.

In particular embodiments, the computing device 516 in a smart meter 510 may track and record energy usage as well as data usage for a particular customer account. Such records may be used for purposes such as billing or data analysis. In particular embodiments, the computing device 516 may request, process, cache, compress, aggregate, route, send, or perform other suitable actions with respect to content carried by the mesh network 500. The computing device 516 may also cause the smart meter 510 to communicate status information to one or more other smart meters 510 and to the control center node 530 via various communications protocols.

In particular embodiments, the computing device 516 may be configured to be easily installable in and removable from the smart meter 510. The computing device 516 may store software programmed to identify a user account that it is associated with and to carry other information associated with the user account, such as a utility or data usage plan purchased by the user. The connection of a smart meter 510 with a user account as well as related account information may be modified by physically swapping the computing device 516 installed in the smart meter 510 with a different one. In regions with extremely low connectivity, beyond the reach of a mesh RF or Wi-Fi network, the computing devices 516 may be periodically brought to a central location for network synchronization. Additionally, a mobile hotspot device, such as a battery-powered smart meter with Wi-Fi or RF antenna could be driven through the low connectivity environment on a motorcycle or bicycle to ensure periodic connectivity, supporting fringe users on the network edge. Alternatively, the computing device 516 may be securely fixed to the smart meter 510. The account information associated with the smart meter 510 may be modified by changing the software encoded in the computing device 516, which may be performed remotely via the mesh network 500. In particular embodiments, each smart meter 510 may also store location information associated with the meter 510 and/or its embedded computing device 516. Such information may comprise the latitudinal and longitudinal coordinates of the meter 510 and may be programmed by a technician when the smart meter 510 is provisioned and/or initialized. The location information may also be made part of the user account information for the customer associated with the smart meter 510. Location coordinates (latitude and longitude) may be determined by the computing device 516 (e.g., using a GPS receiver) and periodically transmitted to a server maintained by a control center node 530, e.g., when the Wi-Fi card 514 has better connectivity. This locational information may be used to build regional maps of customer demographics and usage trends for enhanced utility operations, more precise load forecasting, and informed infrastructure investment planning. More generally, the location information in addition to all data received by the computing device 516 may be made available to the customer through an API for additional and personal use.

In particular embodiments, information collected and records generated by the smart meters 510 may be used for providing additional services to the customers. Information about real-time or historical operations of the electric network may be used to update or validate the pricing of energy, capacity, or ancillary services within the system to maintain safe and reliable operation. The power-distribution system 100 may comprise a customer information database that may track usage and purchases of customers, in addition to the current state of the smart meters 510. The customer information database may develop records correlating information such as meter ID, customer name, use of energy, use of data, consumption of content, payments, locations, connectivity, whether the meter has power, whether someone is tampering with the meter, or other suitable information. Content may also be passively stored as metadata for later use, such as electronic payment history, educational transcripts, electronic health records, or other applications as beneficial for local service providers such as financial institutions, educational institutions, or healthcare providers. As an example and not by way of limitation, a purchase history for a particular customer may be generated based on payment records generated by the smart meters 510. The purchase history may be used to create a credit history for the customers that may be provided to and considered by financial-service providers. Because the utility purchase history can be tied to the particular location of a customer's home, it may offer a more reliable indication of the customer's creditworthiness than, for example, a phone billing history, which may be associated with an individual other than the actual user. As another example, the location information associated with the smart meters 510 may be aggregated and used to create a map of an area covered by the electrical grid. The location information may also be associated with customer's contact information and be used to create a directory, phone book, or database for the customers. Additionally, the meter could store personal records including without limitation, payment history which are retrievable by local healthcare providers and can be linked to geospatial data to locate or correlate, for example, contaminated drinking water sources, based on public health data. As yet another example and not by way of limitation, a service provider may also track content consumption by one or more customers and provide, for example, targeted marketing services based on an analysis of the customers' interests, historical usage profiles, or geographic locations. The personal records may also be used to create an online marketplace for sales of products and services and financial transactions by the users. Such transactions may be done using energy credits, data allowance, or mobile money as the currency.

In particular embodiments, one or more measures may be taken to protect the customers' privacy. As an example and not by way of limitation, a user's permission may be required before certain information is collected or certain records are provided to a third party. As another example and not by way of limitation, a user may be provided with privacy-setting options to determine what information may be publicized or shared. As a further example, the customer may choose to upload certain information directly to third parties, via their customer portal (e.g., in an app on a computing device or in a website), as a means of authentication to the third parties, without making such information visible to the utility operator.

In particular embodiments, one or more functionalities may be built in the mesh network 500 to address potential security concerns associated with the smart meters 510. Such security concerns may arise when, for example, a meter 510 is physically manipulated by an unauthorized individual. As an example and not by way of limitation, the control center node 530 may periodically receive reports containing status information from each smart meter 510. The control center node 530 may determine that one or more smart meters 510 are disconnected from the network 500, flag a security issue, and alert personnel of the utility service provider about the possibility that the disconnected meters are compromised. The notifications may be transmitted by phone, application, SMS, email, or any other means of communication. To reconnect a meter to the mesh network 500, the physical presence of a technician or administrator credentials may be required. Additionally or alternatively, confidential information stored on a smart meter 510 may be erased whenever the meter 510 is removed from the mesh network 500.

In particular embodiments, the utility service provider may allow customers to generate energy, self-consume the locally generated energy, or sell the energy back to the electrical grid. The utility service provider may establish infrastructure required for distributed transactions related to net-metering. Furthermore, a proper incentive structure may be used to encourage efficient and environmentally-conscious use of energy.

In particular embodiments, the power-distribution system 100 may allow one or more customers or other entities to contribute energy to the electrical grid. Each of one or more contributors of energy may possess one or more distributed electricity generation assets (e.g., diesel generators, solar panels, wind mills). Each contributor of energy may be associated with a particular smart meter 510. The particular smart meter 510 may track the contributor's energy contribution to the power-distribution system 100. Similarly, one or more smart meters 510 may be associated with one or more customers that consume energy from the power-distribution system 100. Each of these smart meters 510 may track the power consumption by their respective customers. A customer associated with a particular smart meter 510 may both contribute energy to the power-distribution system 100 and consume energy from the power-distribution system. In this case, the smart meter 510 may track both the contribution and the consumption by the customer. In particular embodiments, one or more computing devices associated with the power-distribution system 100 (e.g., the control center node 530) may dynamically manage the contribution of energy to and consumption of energy from the power-distribution system 100. The computing devices may be connected to one or more smart meters 510 via a network. One or more smart meters 510 associated with one or more energy contributors may send information about energy contributions to the power-distribution system 100 to the control center node 530. Similarly, one or more smart meters 510 associated with customers may send information about energy consumption to the control center node 530. In particular embodiments, the control center node 530 may determine a likelihood of an energy shortage during a specified period of time. It may then send instructions to one or more smart meters 510 to address the predicted energy shortage. The instructions may comprise pricing signals. The instructions may cause one or more smart meters 510 associated with customers to limit consumption of energy during the specified period of time. The instructions may also cause one or more smart meters 510 associated with contributors of energy to increase their energy contribution during the specified period of time. In particular embodiments, the control center node 530 may determine a likelihood of an energy surplus during a specified period of time. It may send instructions to one or more smart meters 510 to decrease energy contribution or increase energy consumption.

In particular embodiments, the power-distribution system 100 may implement a dynamic-pricing system. The power-distribution system 100 may send instructions comprising an update to a value corresponding to one or more units of energy contribution or an update to a value corresponding to one or more units of energy consumption based on the demand and supply of energy in the electrical grid. The power-distribution system 100 may also send instructions comprising an update to a value corresponding to contribution or consumption of energy-related services. Dynamic pricing may be implemented and communicated through the instructions sent from the control center node 530 to the smart meters. In particular embodiments, the energy price for a particular customer may be based on the amount of usage (e.g., an amount of energy consumption by one or more loads associated with a corresponding smart meter 510), the time, the customer's location, the customer's service plan, the customer's longevity on the grid, the customer's aggregate consumption, scarcity of central power supply, another suitable factor, a time (e.g., time of day, week, month, or year) associated with the customer's energy contribution or consumption, an operational state of the electrical infrastructure at the time of energy contribution or consumption, or any combination thereof. As an example and not by way of limitation, the pricing structure may be configured to reward customers using more energy by reducing the per-kWh cost when a customer's energy consumption reaches a pre-determined threshold. As another example and not by way of limitation, the energy price may dynamically fluctuate based on the demand and supply for energy (e.g., higher price during periods of high consumption and lower price at periods of low consumption). As another example and not by way of limitation, Time-of-Use rates may be implemented according to forecasted availability of wind or solar energy, which may directly correlate with particular energy contribution to the grid system, in order to incentivize customer usage of renewable energy (zero fuel cost) rather than burdening the operations of diesel or battery energy sources. Pre-determined pricing information may be communicated to a customer ahead of time. Dynamic pricing information may be communicated to the customer in real time via the mesh network 500 and displayed on a graphic display in the electric meter 150 or via mobile communication, such as SMS or email. As an example and not by way of limitation, pricing information may be sent as part of the instructions from the control center node 530 to the smart meters 510.

In particular embodiments, the power-distribution system 100 may dynamically adjust a consumption allowance for customers based on changes to energy supply. Specifically, the instructions sent by the control center node 530 may comprise an update to a maximum limit on energy consumption attributable to a particular smart meter 510. As an example and not by way of limitation, an electric meter 150 may normally be configured to provide a maximum of a 15 A current at 120 V. However, during an energy-shortage incident (e.g., shortage of fossil fuel used to generate electricity or low state-of-charge on battery bank), the administrator of the power-distribution system 100 may demand response by customers by lowering the current limit to 10 A. This change may instantaneously cut off power supply for customers who are using more than 10 A. The electrical grid may reset power supply to these customers after a first period of time (e.g., 5 seconds). If a customer's power demand is not reduced below 10 A, the power supply will be cut off again. The power supply may reset after a second period of time (e.g., 30 seconds). This process may repeat until the customer adjusts her power consumption below the limitation, at which time, consistent power supply will be restored until the threshold is either exceeded or lowered. Real-time notifications of demand response events may be provided via the visual display on the electric meter 150 or via mobile communication, such as SMS or email. Alternatively or additionally, the power-distribution system 100 may address a power-shortage incident by sending instructions carrying an update to a minimum limit on energy contribution attributable to a particular smart meter. In particular embodiments, the power-distribution system 100 may also send instructions that comprise an update to a threshold amount of allowable balance of energy credit on one or more of the smart meters 510 prior to interruption of pre-paid electricity service. The power-distribution system 100 may also send instructions that comprise an update to a unit of measure for energy contribution or consumption for each of one or more smart meters 510.

Similarly, the utility operator may also enforce minimum power limitations during both normal and emergency conditions. For example, if a customer has not been a reliable user of the system or has been found to circumvent the system, the customer's smart meter 510 may require some minimum balance, for example $10 in order to keep the power on. When this customer dips below $10 balance, he may lose power, whereas other customers may run their balance all the way down to zero. Conversely, certain customers that provide vital public services, such as health clinics or cell phone towers, may be allowed to incur a negative balance, for example up to $1,000 in a line of credit extended by the utility service provider and managed by the corresponding smart meter 510. Such customers may be invoiced on a monthly basis for ease of invoicing and payment processing from a centralized accounts payable department for multiple accounts. All customers may receive automated alerts via a screen of their smart meters 510, or a beeping sound on the smart meters 510, or automated SMS or email, or other appropriate means, when their balance is reaching a critically low level.

In particular embodiments, a utility service provider may incentivize particular behavior of energy contributors and customers through instructions sent to one or more smart meters 510. In particular embodiments, a control center node 530 associated with a utility service provider may create a forecast or prediction related to energy contribution or consumption. The forecast or prediction may be based on, for example, an energy contribution capacity of each of one or more smart meters associated with energy contributors, a history of energy contribution for each of one or more smart meters associated with energy contributors, an energy forecast for each of one or more generation assets (solar forecast, wind forecast, hydro forecast, diesel fuel levels) associated with one or more smart meters, a state-of-charge of each of one or more battery banks associated with one or more smart meters, a history of energy consumption for each of one or more smart meters, other suitable information, or any combination thereof. The utility service provider may, for example, submit a day-ahead or hour-ahead forecast to customers and energy contributors (e.g., market participants). To the extent that there is a shortfall in energy contribution compared to the forecast, or in the event that such a shortfall arises in real-time, the utility may incentivize energy contributors to contribute energy to the system or incentivize customers to use less. Therefore, customers may voluntarily opt-in to a time-delimited curtailment event, whereby they agree to have their meter limited to a particular current over a particular peak load period, in exchange for some compensation. These customers may essentially be waiving their option to consume some or all of their metered allotment of electrical energy during these hours. In particular embodiments, the control center node 530 may detect an energy surplus and send instructions to prevent energy contributors with oversized generating capacities from power waste and result in a more environmentally-friendly ecosystem. The utility service provider may compensate customers proportional to the level of load reduction and the severity of network constraints. A utility service provider may thereby utilize the automatic demand response function of the smart meters to purchase “nega-watts” of non-consumed energy from its customers in addition to positive megawatts of energy production. Additionally, if a customer was away from home for an extended period of time, they may opt into permanent curtailment, offering certainty to the utility-service provider that their meter will never need to be supplied with power over a set period of time and potentially earning small amounts money during a vacation or absence from home in exchange for greater operational certainty by the utility-service provider. Conversely, to the extent that there is a surplus in energy production compared to the forecast, or in the event that such a surplus arises in real-time, the utility may incentivize non-essential energy contributors to refrain from producing energy in the system or incentivize customers to use more. Therefore, flexible users may recognize economic benefits by performing additional productive uses of electricity, e.g., pumping water or making ice, during instances where for example solar energy is producing surplus power and battery banks are nearly full. If such energy was not consumed in productive uses, it may merely be wasted by the solar inverters, or it may risk damage to diesel generators. Therefore, the utility may use load forecasting and customer interfaces to adjust real-time price signals to incentivize desired participatory customer behavior to increase reliability.

In particular embodiments, the main service line 160 and/or the electric meter 150 for each customer premise 170 may comprise two connections: one must-run circuit and one interruptible circuit. The customer may selectively connect particular loads to either connection. During a power shortage, power may be preferentially supplied to the must-run circuit, or this circuit may be exempted from demand response or automatic load shedding. However, power supply to the interruptible circuit may not be guaranteed. In particular embodiments, the price for electricity from both connections may be the same during normal hours. When a power shortage or other operational constraint occurs, however, electricity from the must-run circuit may be billed at a must-run rate that is significantly higher and intended to serve critical loads. This allows a customer to balance the benefit of a continuous power supply with potential high cost. A customer may choose to only connect essential loads (e.g., X-ray machine, refrigerator for keeping vaccines) to the must-run circuit or may move loads from the interruptible circuit to the must-run circuit if a non-critical load (e.g., a television, a cell phone charger) is deemed critical at the time of the curtailment event. In particular embodiments, the power-distribution system 100 may also divide the electric meters 150 into one or more groups based on the priority of their corresponding operations. At a power shortage, energy may be preferentially supplied to the electric meters 150 that correspond to operations with a high priority.

In particular embodiments, one or more electricity generators may be installed at one or more customer premises, making the corresponding customers energy contributors. The electricity generators may comprise one or more fossil fuel generators (e.g., diesel generator) or one or more renewable energy generators (e.g., solar generator, wind generator). In particular embodiments, the electricity generators may be connected to their corresponding customer premise 170. The generated electricity may be locally consumed or stored. The electricity generators may also be connected to the power-distribution system 100. The power-distribution system 100 may allow the electricity generators to send energy to the generating station 110 or to one or more other customer premises 170. In particular embodiments, the electricity generated by a particular customer may be sold back to the utility service provider via net metering or to one or more other customers. As an example and not by way of limitation, the power-distribution system 100 may comprise one or more solar generators that are productive only during daytime. The utility service provider may set energy price low during daytime, when supply is abundant, and high during nighttime or may adjust price signals in real-time based on other operational or economic metrics. A customer may own a diesel generator or a battery bank. Given the pricing structure set by the utility service provider, the customer may decide to purchase energy from the grid over the day to take advantage of the low price; the customer may operate the diesel generator at night and sell the electricity generated to make a profit. In this way, the utility operator may achieve greater reliability of power supply by enabling customer participation in real-time energy management decisions. In the example described above, the utility may have augmented its regulating reserves and operating margin merely via customer price signals, without any additional infrastructure, capital expenses, labor, or fuel required. In under-resourced environments, these participatory methods may reduce the operational costs of frontier electricity service while creating local revenue opportunities for end users. This may allow a utility service provider to create distributed, decentralized markets for ancillary services such as voltage or frequency regulation among unsophisticated customer networks whose individual behavior can be aggregated into measurable improvements in reliability indices, and who may be compensated accordingly.

With the smart meters 510 enabled for receiving and propagating location- and time-based price incentives, the network may offer a Locational Marginal Price (LMP) analogous to a nodal transmission market in large interconnected electric utility systems. The LMP may include a Locational Loss Component (LLC) based on the distance from the power source to the load center, i.e. value of each energy unit (kWh) may be adjusted proportionally to the incremental amount of technical line losses created or exacerbated by this transmission/distribution path during these hours of delivery. The LMP may also include a Locational Congestion Component (LCC), which reflects the incremental contribution of each energy unit to transmission/distribution congestion, i.e. whether this delivery path exacerbates or alleviates the prevailing flows of energy in the power-distribution system 100 at a particular time. The LMP may also include various additional variable price components to adjust compensation for transactions occurring over the network at a particular location in a particular time. These factors may allow for a deregulated exchange of electricity and ancillary services on a peer-to-peer bilateral or nodal basis, managed by an impartial utility service provider and allowing for many users to derive revenue from reliable operation of the power-distribution system 100. Additionally, customers with distributed generating units, such as hotels, may be included in a capacity marker, whereby they may be compensated to keep their generation units in good working order, ready to support back-up operations within the electrical grid in the event of emergency condition. These generators may be guaranteed capacity revenue if they don't operate or energy revenue if they do operate, offering a low risk opportunity to the customer to earn money by augmenting utility operations and creating a network-wide “Virtual Power Plant” composed of distributed generation assets as well as flexible customer load equipment which may offset generation and load fluctuation on the network, allowing for even higher penetration of renewable energy than would otherwise be advisable in a traditional electrical grid without compromising reliability.

In particular embodiments, energy transactions among customers may be administered in a centralized manner by the utility service provider. Alternatively, the transactions may be administered in a decentralized manner or on a peer-to-peer basis by the one or more smart meters 510 collectively. In particular embodiments, a blockchain data structure may be employed to facilitate the decentralized management of transactions. A blockchain may comprise a continuously growing list of records that are linked and secured using cryptography. Each smart meter 510 within the mesh network 500 may comprise software that is operable to manage a distributed transaction ledger containing one or more transaction records (e.g., a blockchain transaction ledger). The transaction records may be associated with a transfer of electric energy, a consumption of data, another suitable transaction, or any combination thereof. The blockchain transaction ledger or components thereof may be distributed among a plurality of smart meters 510 in the mesh network 500. Each smart meter 510 may independently store a copy of the blockchain transaction ledger and periodically refresh to the latest state of the ledger. Periodic updating may allow quick and accurate transaction validation.

A smart meter 510 may execute or detect a transaction associated with its corresponding customer. The transaction may have occurred between the customer and another customer (e.g., selling of a particular amount of electricity, data, or products at a particular price), between the customer and the utility service provider (e.g., a monthly payment for data services), or between any suitable parties. The smart meter 510 may generate a transaction record containing information associated with the transaction. The transaction record may further contain information such as an identifier of the customer, an account balance of the customer, a location of the customer, an energy usage history of the customer, a timestamp, other suitable information, or any combination thereof. The smart meter 510 may then broadcast this transaction record to one or more other smart meters 510 via the mesh network 500 for validation. The smart meter 510 may also send the transaction record to the control center node 530 for validation. The smart meters 510 that receive the transaction record or the control center node 530 may validate the transaction record using cryptography techniques (e.g., executing one or more scripts based on public-key cryptography and associated with the transaction record). Additionally or alternatively, the smart meters 510 may validate the transaction record by sending the transaction record to a third-party validation computer server and receiving a response from the third-party validation computer server indicating whether the transaction record is valid. The validation computer server may be associated with the control center node 530, the utility service provider, an electrical grid manager, a neutral transaction auditor, another suitable entity, or any combination thereof. A transaction record may remain pending until validated by the mesh network 500. Upon validating the transaction record, each smart meter 510 may update the copy of the blockchain transaction ledger it stores to incorporate the transaction record. The control center node 530 may also updated its copy of the blockchain transaction ledger to incorporate the transaction record. The transaction record may thereby be redundantly stored in a plurality of copies of the blockchain transaction ledger and/or on a control center node 530. On the other hand, a transaction record that cannot be validated may be deleted.

In particular embodiments, a smart meter 510 may combine a particular transaction record with one or more other transaction records within a block to be added to the blockchain transaction ledger. The smart meter may determine a position of the particular transaction record within the block. This block may be broadcasted to one or more other smart meters 510 and the control center node 530 for independent validation. In particular embodiments, the blockchain transaction ledger may comprise a plurality of blocks, each comprising a reference to a preceding block. The update process for a particular smart meter 510 may comprise the smart meter 510 determining a position for a new block in the blockchain transaction ledger and adding the new block to the blockchain transaction ledger. The smart meter 510 may determine a priority relationship between one or more blocks. It may dispose of one or more blocks due to failure to validate or lack of priority. In particular embodiments, the transmission of transaction records or blocks may be facilitated by encrypted communication techniques. A first smart meter 510 may encrypt a transaction record before broadcasting it. A second smart meter 510 may decrypt the transaction record after receiving the transaction record and before validating it. In particular embodiments, the transmitted data may be encrypted by encryption keys identifying corresponding smart meters 510, which may or may not correspond to encryption keys used in active anti-theft by the scramblers 132 and 152 and descramblers 134 and 154.

In particular embodiments, the control center node 530 may contain a copy of the blockchain transaction ledger. The control center node 530 may compare its copy of the blockchain transaction ledger with those stored on one or more smart meters 510. It may synchronize or verify one or more of the copies of the blockchain transaction ledger. The control center node 530 may also broadcast one or more transactions executed by the utility service provider (e.g., deposit of money in an account or electricity consumption over a period of time) to the smart meters 510 for validation. The control center node 530 may detect one or more disparities between its record and the records stored at one or more smart meters 510. The disparities may often be reconciled by updating one or more copies of the blockchain transaction ledger. In particular situations, a disparity may suggest that the system is compromised and cause an alert to be sent to an administrator. As an example and not by way of limitation, in a power-distribution system in which a refill of an account balance can only be processed at the control center node 530 and a deduction of the balance can only be processed at a smart meter node 510, a disparity involving the control center node 530 showing a lower account balance than a smart meter node 510 may trigger such an alert.

In particular embodiments, the smart meters 510 within the mesh network 500 may maintain transaction records without the interference of the control center node 530. In situations where one or more the network connections of one or more smart meters 510 to the control center node 530 is lost, the smart meters 510 may continue to form a local-area network and maintain duplicated copies of the blockchain transaction ledger within the local-area network. The information maintained by these smart meters 510 may be transmitted to the control center node 530 when the network connection is re-established. In situations where a particular smart meter 510 is disconnected from all other nodes within the mesh network 500, the smart meter 510 may continue to manage its corresponding customer's energy usage (e.g., terminating energy supply when the customer's account balance is depleted). The smart meter 510 may continue to update its copy of the blockchain transaction ledger and broadcast transaction information when its network connection is re-established. It may also then receive information associated with other transactions that occurred during the disconnection from one or more other nodes.

In particular embodiments, various software interfaces may be created to facilitate the distributed management of transactions. The software interfaces may comprise a customer application, a vendor application, a technician application, an administrator application, or other suitable applications. Each application may be implemented in various formats, such as browser applications or smart-phone applications. In particular embodiments, the customer application may comprise software managing and storing the blockchain recording peer-to-peer transactions, which allows the customer to also be an energy vendor. The customer application may further allow a customer to set customized prices for selling or purchasing energy. The customer may be allowed to set different selling prices for different time periods (e.g., day rate v. night rate) or for different target buyers (e.g., friends and family rate v. stranger rate v. utility manager rate). The customer application may also be configured to perform other suitable customer operations. The vendor application may allow an energy vendor to initiate or authorize transactions, set prices, manage commissions, or perform other suitable vendor operations. The technician application may allow an authorized individual to create or destroy customer profiles, access status information of the power-distribution system (e.g., measurements of current, voltage, frequency), or perform other suitable technician operations. The technician users will also interface with the Automatic Technician Deployment System (ATDS), which geotags a customer in need of technical support and offers a price for completing the work. Technicians on call may receive an alert of the work order “ticket” and accept the work order, via their mobile device, without direct communication with the headquarters office. The technician may also be dispatched to a particular meter 510 by a grid operator. Upon accepting a work order, the technician's location may be tracked by a web portal, a phone application, or other appropriate interfaces. When responding to the work order, the technician may claim the assigned work and notify other technicians that the work is in process. The application may record the hourly time of the work and assign time-based compensation to the technician in an automatic payroll system. Upon successful completion of the work order, the technician may be paid either with energy credits for their account or mobile money in real time. The administrator application may allow an administrator to authorize account modifications, correct balance transfers or transactions that may have not been fulfilled on the server, or perform other suitable administrator operations. Administrators may also choose to inspect the completed work or request field documentation or photos from the job site before authorizing payment.

The blockchain transaction ledger may also enable an Outage Detection and Dispatch System (ODDS), whereby the utility service provider may detect disturbances or outages within the power-distribution system 100 and/or mesh network 500 via an interruption in connectivity or specific technical parameters in the smart meter network 500. Smart meters 510 may be aggregated into an “Internet of Things” (Internet of Energy) sensor array, which may be programmed to sense specific grid “state-of-health” parameters on finite intervals (e.g., each second) and communicate the parameters to the control center node 530. In the event that nodes are missing or inaccessible in real-time, the control center node 530 may facilitate distribution automation procedures, whereby the mesh network 500 may seek available on-demand energy resources within the region that has lost power. Energy contributors within a blackout region may be offered a premium price to supply energy to their neighbors during the outage or may opt-in to auto-start their distributed generation assets during a blackout event until normal power is restored for predetermined compensation levels. These incentives may yield a “self-healing” electrical network, whereby customer asset automation may respond more quickly than utility service providers to increase grid reliability and leverage embedded generation, transmission, and distribution redundancy. This may enable the electrical grid infrastructure to behave more like a mesh communications network, whereby multiple routes of transmission are able to serve demand, but with an added incentive of real-time economic settlements via blockchain transactions either prearranged or conducted in real-time. Alternatively, once the distribution automation procedures have alerted the control center node 530 and other customer networks of the outage condition, further corrective or precautionary automation may occur. For example, if technicians are actively working on a downed power line, then distributed generation may present an occupational hazard to active technicians. Once technicians arrive at the job site, they may forbid localized power generation via an automated “lock-out/tag-out” procedure to ensure safe work conditions.

In particular embodiments, a smart meter 510 may be equipped with load signature recognition, whereby the smart meter 510 may determine what type of devices are connected at any given time. As an example and not by way of limitation, customers may choose to cook with electric griddles or hotplates, which may have very resistive impedance yielding a high power factor and characterized by intermittent heating and idle periods, driven by a thermostat. These characteristics may be distinguished from a television, light bulb, or cell phone charger, for example, and would not be possible to replicate with those devices. This load signature may offer a time-varying pattern which may be recognized by the smart meter 510 to offer specific incentives to customers who are cooking electrically.

In particular embodiments, a smart meter 510 may interact with in-home devices that are smart-grid (IoT) enabled with wireless transmission capabilities of their own. For example, a customer may purchase a high efficiency refrigerator which makes energy optimized decisions and saves power. This refrigerator may have onboard sensors which can receive signals from the wider utility network for curtailment or peak pricing events. This refrigerator may also help customers to optimize energy consumption during premium pricing hours and also conserve energy without requiring direct participation or interaction by the end user.

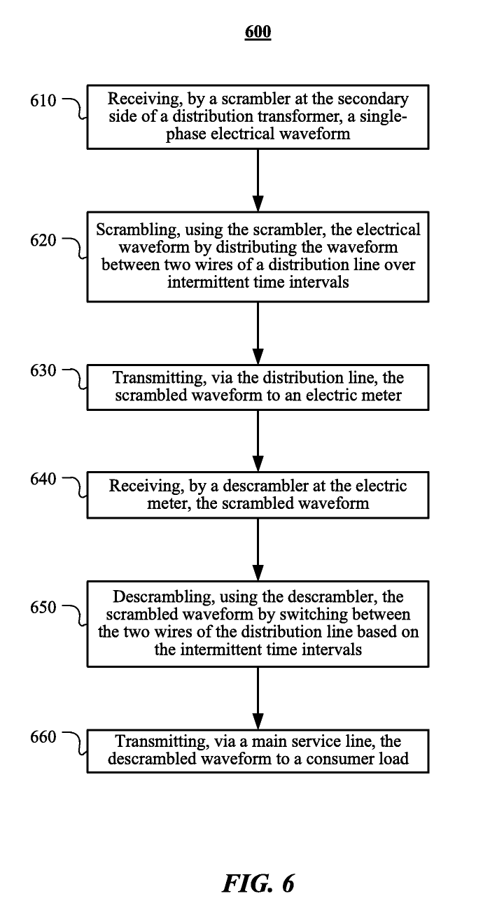

FIG. 6 illustrates an example method 600 for actively preventing energy theft by encrypting electricity transmitted in a power line. The method may begin at step 610, where a scrambler 132 located at the secondary side of a distribution transformer 130 may receive a single-phase electrical waveform 210. At step 620, the scrambler may scramble the electrical waveform 210 by distributing the waveform between two wires of a distribution line 140 over intermittent time intervals. At step 630, the scrambled waveform 230-240 may be transmitted to an electric meter 150 associated with a customer via the distribution line 140. At step 640, a descrambler 154 located at the electric meter 150 may receive the scrambled waveform 230-240. At step 650, the descrambler may descramble the scrambled waveform 230-240 by switching between the two wires of the distribution line 140 based on the intermittent time intervals. At step 660, the descrambled waveform may be transmitted to a consumer load via a main service line 160. Particular embodiments may repeat one or more steps of the method of FIG. 6, where appropriate. Although this disclosure describes and illustrates particular steps of the method of FIG. 6 as occurring in a particular order, this disclosure contemplates any suitable steps of the method of FIG. 6 occurring in any suitable order. Moreover, although this disclosure describes and illustrates an example method for actively preventing energy theft by encrypting electricity transmitted in a power line including the particular steps of the method of FIG. 6, this disclosure contemplates any suitable method for actively preventing energy theft by encrypting electricity transmitted in a power line including any suitable steps, which may include all, some, or none of the steps of the method of FIG. 6, where appropriate. Furthermore, although this disclosure describes and illustrates particular components, devices, or systems carrying out particular steps of the method of FIG. 6, this disclosure contemplates any suitable combination of any suitable components, devices, or systems carrying out any suitable steps of the method of FIG. 6.

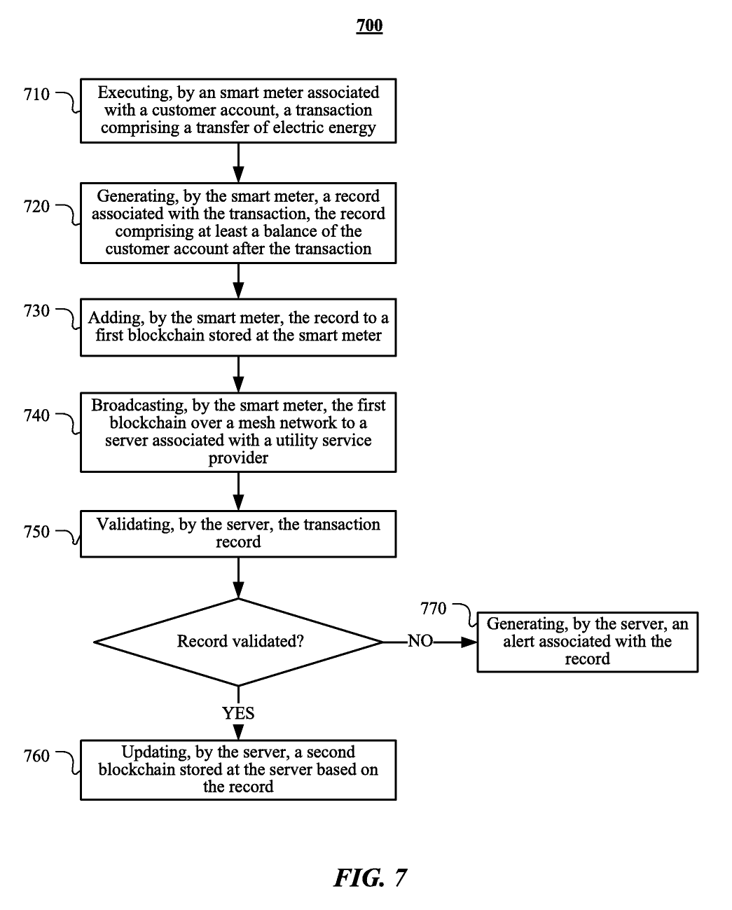

FIG. 7 illustrates an example method 700 for recording and verifying decentralized energy transactions. The method may begin at step 710, where a smart meter 510 associated with a customer account may execute a transaction comprising a transfer of electric energy. At step 720, the smart meter 510 may generate a record associated with the transaction, the record comprising at least a balance of the customer account after the transaction as well as additional metadata peripheral to the transaction, but relevant to additional services. At step 730, the smart meter 510 may add the record to a first blockchain stored at the smart meter 510. At step 740, the smart meter 510 may broadcast the transaction record over a mesh network 500 to a server 530 associated with a utility service provider. At step 750, the server may attempt to validate the transaction record. If the record is validated, the method 700 may proceed to step 760, where the server 530 may update a second blockchain stored at the server 530 based on the transaction record. If the record is not validated, the method 700 may proceed to step 770, where the server 530 may generate an alert associated with the transaction. The alert may be reviewed by personnel of the utility service provider to determine whether further actions are appropriate. Particular embodiments may repeat one or more steps of the method of FIG. 7, where appropriate. Although this disclosure describes and illustrates particular steps of the method of FIG. 7 as occurring in a particular order, this disclosure contemplates any suitable steps of the method of FIG. 7 occurring in any suitable order. Moreover, although this disclosure describes and illustrates an example method for recording and verifying decentralized energy transactions including the particular steps of the method of FIG. 7, this disclosure contemplates any suitable method for recording and verifying decentralized energy transactions including any suitable steps, which may include all, some, or none of the steps of the method of FIG. 7, where appropriate. Furthermore, although this disclosure describes and illustrates particular components, devices, or systems carrying out particular steps of the method of FIG. 7, this disclosure contemplates any suitable combination of any suitable components, devices, or systems carrying out any suitable steps of the method of FIG. 7.

In particular embodiments, a blockchain is a data structure that may comprise an ordered, back-linked list of data records. The data records in a blockchain may be included in a plurality of blocks, each of which (except a genesis block) may comprise a reference to a preceding block. A blockchain may be used to enable various applications. For example, it may be used as a shared ledger of time-stamped transactions, which may facilitate efficient and secure recording of transactions among a plurality of parties.

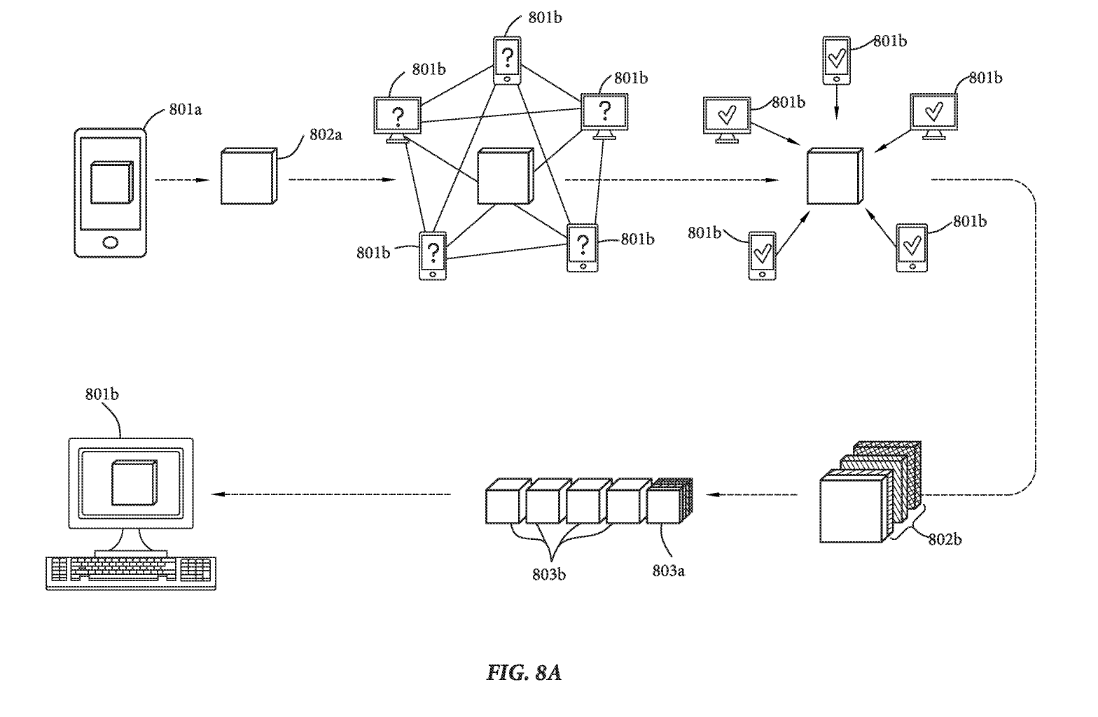

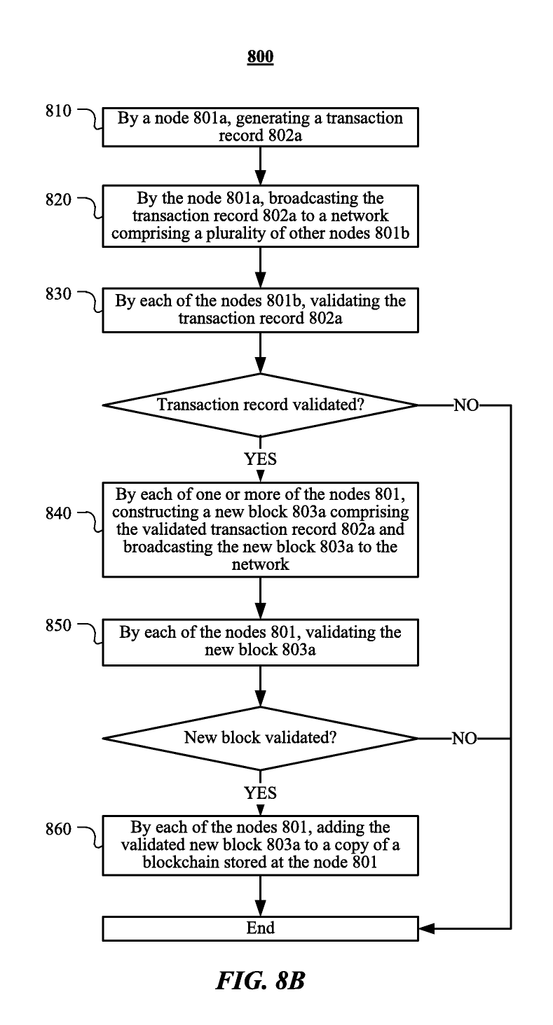

FIGS. 8A and 8B illustrate an example method 800 for recording a transaction in a blockchain. In particular embodiments, at step 810, a node 801a may generate a transaction record 802a. The node 801a may comprise a computing system (e.g., a data center, a computer server, a personal computer, a mobile device, a smart meter, a single-board computer, a special-purpose circuit, a GPU) associated with a user. In particular embodiments, the node 801a may comprise one or more client applications configured to execute a protocol for blockchain management. The functionalities of the one or more client applications may comprise storing one or more identifiers of an account associated with the user created using, for example, public-key cryptography, storing and updating a copy of a distributed blockchain, creating transactions, validating transactions, aggregating transactions to create blocks, validating blocks, discovering and maintaining connections to peer nodes, or performing one or more other suitable actions. The client applications may also support more than one accounts associated with the first user. In particular embodiments, each account may be associated with one or more private-public key pairs generated randomly or derived from a common seed. The private keys may be protected by one or more data-security methods. In particular embodiments, the transaction record 802a generated by the node 801a may comprise information about an input and an output associated with a corresponding transaction. The input may comprise one or more identifiers referencing one or more outputs of one or more previous transactions, information to establish control or ownership over the referenced output of the previous transaction, a digital signature created based on a private key associated with the account, a public key associated with the account and the private key, or other suitable information. The output may comprise a description of the subject of the transaction (e.g., an amount of assets, information, contract rights), a cryptographic puzzle that determines conditions required to take control or ownership of the output, information about or derived from a public key or address of an intended recipient account (the address may comprise a hash of the public key), or other suitable information. A merkel tree may also be used as a means to protect the private keys.

In particular embodiments, the transaction key may be a result of physical parameters on an electric grid. For example, all of the electric meters in the grid may experience the same frequency at any given time. If the real-time grid frequency were used as the encryption key, then this may not be known to the outside world without a physical sensor to determine the necessary parameter driving the key. Alternatively, each node on the grid may experience a different voltage, which may fluctuate from time to time allowing for each meter to use a unique key for its local encryption. Since the voltage may be reported to the server separately from the transaction history, real-time voltage modulation may offer a dynamic encryption key, unique to each meter, time-varying, and very difficult to hack externally without access to not only the transaction records, but also the technical data on each meter in real time.

At step 820, the node 801a may broadcast the transaction record 802a to a network comprising a plurality of other nodes 801b running client applications for executing the protocol for blockchain management. The network may further comprise one or more nodes 801 running one or more protocols incompatible with that run by the client applications associated with the node 801a, but connected to the network by one or more gateway routing servers. In particular embodiments, the network may be a non-hierarchical peer-to-peer (P2P) network. Alternatively, it may be a hierarchical network comprising one or more nodes having authority or administrative functionalities over other nodes (e.g., nodes maintained by vendors, technicians, administrators, customers). The architecture of the network may be structured on top of and based on the internet. Data transmitted within the network may be accessible to the public. Alternatively, one or more network connections associated with the network may be protected by encryption or authentication. In particular embodiments, when the network is a P2P network, a new node 801 may be added to the network by establishing a Transmission Control Protocol (“TCP”) connection with at least one existing node 801 and performing a “handshake” with the existing node 801. The handshake may comprise exchanging information such as version information of the client applications or the protocol for blockchain management run by each node 801, a list of local services supported by each node 801, an IP address of each node 801, information about a copy of the blockchain stored at each node 801, or other suitable information. The existing node 801 may forward information about the new node 801 to one or more other existing nodes 801 and provide address information about one or more other existing nodes 801 to the new node 801, which would allow the new node 801 to discover and connect to additional nodes 801. Each node 801 may compare information about its own copy of the blockchain with such information received from a connected node 801. If a node 801 determines that a connected node 801 stores a fuller or newer copy of the blockchain (e.g., a blockchain with a greater height or number of blocks), it may request blockchain data from the connected node 801 and synchronize its copy of the blockchain to the fuller or newer copy.

At step 830, when a node 801b receives the transaction record 802a from the node 801a, it may independently validate the transaction record 802a. The node 801b may forward the transaction record 802a to one or more other nodes 801b if the transaction record 802a is validated. Otherwise, the node 801b may delete the transaction record 802a. This may ensure that only valid transaction records propagate across the network. The validation may comprise validating that the node 801a has satisfied the conditions for control or ownership over the output of a previous transaction that is referenced by the transaction record 802a. In other words, this may verify that the node 801a possesses the subject of the transaction 802a. In particular embodiments, the validation may be based on public-key cryptography. As an example and not by way of limitation, the validation may be based on a locking script and an unlocking script. The locking script may be included in the previous transaction referenced by the transaction record 802a and may specify one or more conditions that must be met for establishing control or ownership over the output of the referenced previous transaction. The unlocking script may be constructed by the node 801a based at least in part on the locking script, a public key associated with the node 801a, and a digital signature created based on a private key associated with the node 801a. Each node 801b may validate the transaction record 802a by executing the unlocking script and the locking script in sequence, which may return a Boolean value. The Boolean value True may correspond to successful validation. In particular alternative embodiments, the validation may be based on authentication of the transaction 802a and its corresponding account by a trusted authority. In particular embodiments, each node 801b receiving the transaction record 802a may further validate various other aspects of the transaction record 802a including, for example, the syntax and data structure of the transaction record 802a being correct, the size of the transaction record 802a being within a predetermined range, the value of the output of the transaction record 802a being within a predetermined range, the existence of a previous transaction referenced by the transaction record 802a in the blockchain or a pool of recently received transactions, current availability of an output of a previous transaction referenced by the transaction record 802a, the input of the transaction record 802a being sufficient to provide for the output of the transaction record 802a, the inclusion of any required transaction fees, or other suitable aspects of the transaction record 802a. The validation may require searching transactions in the blockchain for one or more previous transactions referenced by the transaction record 802a. If a node 801 stores a copy of the entire blockchain, it may perform the search locally. If a node 801 does not store a copy of the entire blockchain, it may request particular blocks of the blockchain or headers of particular blocks from one or more of its network connections. If a node 801b successfully validates the transaction record 802a, it may forward the transaction record 802a to one or more other nodes 801b in the network.

In addition to validating and forwarding a transaction record 802a, client applications associated with one or more of the nodes 801 may aggregate the transaction record 802a with a plurality of other transaction records 802b into a new block 803a for the blockchain. At step 840, a node 801 may construct a new block 803a by aggregating a plurality of received and validated transactions 802 that have not been included in a copy of the blockchain that the node 801 stores and broadcast the new block 803a to the network. An existing cycle of block construction may be terminated and a new cycle started either when the node 801 successfully constructs a new block or when the node 801 receives a valid new block from another node 801. The node 801 may construct the new block 803a such that it can be linked to the newest block in the copy of the blockchain stored by the node 801. In particular embodiments, the newly-created block 803a, like each of the other blocks 803b, may comprise a header and a plurality of transaction records 802. Each block 803 may further comprise one or more additional fields, such as a block-size field specifying the size of the block 803 and a transaction-counter field specifying the number of transactions included in the block 803.

In particular embodiments, the header of each block may comprise metadata including, for example, a reference to a block hash of a parent block, a summary of the transaction records included in the block, or other suitable data. The block hash of a particular block 803 may comprise a cryptographic hash of the header of the block 803 and may identify the block 803 uniquely and unambiguously. In particular embodiments, a parent block's block hash may be included in a header of its child block (i.e., a block that connects to the parent block in the blockchain and that comprises a reference to the parent block). The header of the child block may then be used to compute the child block's block hash, which may be included in a grandchild block's header. This way, the header of every block 803 may be dependent on the headers of all previous blocks 803 in the blockchain up to a genesis block (e.g., the very first block of a blockchain). It may thus be impossible to change the header of one block 803 in the blockchain without having to change the header of each of its descendants. In particular embodiments, the summary of the transaction records in the block 803a may comprise the root of a binary hash tree (or merkle tree), which may be obtained by recursively hashing pairs of nodes in the binary hash tree. The leaf nodes of the binary hash tree may each comprise a cryptographic hash of one of the transaction records 802 included in the block 803a. A node 801 may efficiently prove the existence of a particular transaction record 802 in a block 803 by traversing the binary hash tree.

In particular embodiments, the protocol for blockchain management may structure a computationally resource-consuming challenge in the creation process for each new block 803. As an example and not by way of limitation, each node 801 may be required to include a solution satisfying a particular challenge (or a “proof-of-work”) in the header of a newly-created block 803 before any other node 801 accepts the block as valid. The protocol may also provide a reward to any node 801 that creates a new block 803 that is eventually included in the blockchain. One or more different nodes 801 may compete to solve the challenge quickly in order to reap the reward. The inclusion of such resource-consuming challenges may make it difficult for any node 801 or group of nodes 801 to attack the security of the blockchain, which may require fast creation of a number of compromised but formally valid blocks. In particular alternative embodiments, the protocol may allow one or more verified and trusted entities to aggregate transactions and construct blocks 803. The trusted entities may be related to a trusted authority associated with the network of nodes. A new block 803 created by a trusted entity may be automatically validated without proof of satisfaction of a particular challenge. After creating a valid new block 803, the node 801 may broadcast it to one or more other nodes 801 in the network.

At step 850, each node 801 receiving a new block 803a may validate the new block 803a. If the new block 803a is validated, the node 801 may add the new block 803a to its copy of the blockchain at step 860. Otherwise, the node 801 may delete the new block 803a. The blockchain may comprise one or more existing blocks 803b. A node 801 may validate various aspects of the new block 803a including, for example, the syntax and data structure of the block being correct, the size of the new block 803a being within an acceptable range, a timestamp included in the new block 803a being within an acceptable period, each transaction record 802 in the new block 803a being valid, a proof of satisfaction of any required challenge being present, or other suitable aspects. Once the new block 803a is validated, the receiving node 801 may identify a reference to the intended parent block 803b of the new block 803a. It may search through its copy of the blockchain to identify the referenced parent block 803b and link the new block to the identified parent block 803b. It may further broadcast the new block 803a to one or more connected nodes 801. In particular embodiments, no block 803b matching the reference to the intended parent of new block 803a may have been included in the blockchain stored by a receiving node 801. In this case, the node 801 may temporarily store the new block 803a in a pool of received blocks and add the new block 803a to the blockchain if a block 803b matching the reference is subsequently received. In particular embodiments, the block 803b referenced by the new block 803a as its parent may not be the newest block in the blockchain stored by the node 801. In this case, it may be determined that a “fork” event in the blockchain occurs because at least the referenced parent block 803b has more than one child blocks 803, thus forming at least two “branches.” The node 801 may select one of the “branches” as a main branch of the blockchain based on one or more rules specified in the protocol for blockchain management. As an example and not by way of limitation, the rules may require the node 801 to select the branch that represents the most proof-of-work or, often, the longest or most complicated branch (in case one or more blocks contain references to more than one preceding blocks). A potential tie between two existing branches may be broken by one or more newly received blocks 803. Given that all nodes 801 obey the same rules for resolving fork events, the P2P network may eventually form a decentralized consensus treating a particular branch as the “true” copy of the blockchain. All other branches of a fork event may be removed by each of the nodes 801. In particular alternative embodiments, the protocol for blockchain management may allow for different branches to co-exist and propagate independently.

Particular embodiments may repeat one or more steps of the method of FIG. 8B, where appropriate. Although this disclosure describes and illustrates particular steps of the method of FIG. 8B as occurring in a particular order, this disclosure contemplates any suitable steps of the method of FIG. 8B occurring in any suitable order. Moreover, although this disclosure describes and illustrates an example method for recording a transaction in a blockchain including the particular steps of the method of FIG. 8B, this disclosure contemplates any suitable method for recording a transaction in a blockchain including any suitable steps, which may include all, some, or none of the steps of the method of FIG. 8B, where appropriate. Furthermore, although this disclosure describes and illustrates particular components, devices, or systems carrying out particular steps of the method of FIG. 8B, this disclosure contemplates any suitable combination of any suitable components, devices, or systems carrying out any suitable steps of the method of FIG. 8B.

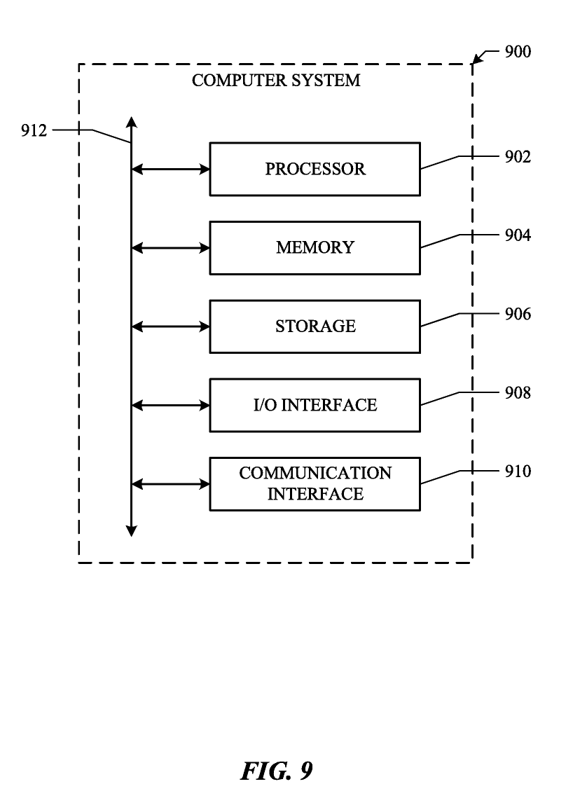

FIG. 9 illustrates an example computer system 900. In particular embodiments, one or more computer systems 900 perform one or more steps of one or more methods described or illustrated herein. In particular embodiments, one or more computer systems 900 provide functionality described or illustrated herein. In particular embodiments, software running on one or more computer systems 900 performs one or more steps of one or more methods described or illustrated herein or provides functionality described or illustrated herein. Particular embodiments include one or more portions of one or more computer systems 900. Herein, reference to a computer system may encompass a computing device, and vice versa, where appropriate. Moreover, reference to a computer system may encompass one or more computer systems, where appropriate.

This disclosure contemplates any suitable number of computer systems 900. This disclosure contemplates computer system 900 taking any suitable physical form. As example and not by way of limitation, computer system 900 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 900 may include one or more computer systems 900; be unitary or distributed; span multiple locations; span multiple machines; span multiple data centers; or reside in a cloud, which may include one or more cloud components in one or more networks. Where appropriate, one or more computer systems 900 may perform without substantial spatial or temporal limitation one or more steps of one or more methods described or illustrated herein. As an example and not by way of limitation, one or more computer systems 900 may perform in real time or in batch mode one or more steps of one or more methods described or illustrated herein. One or more computer systems 900 may perform at different times or at different locations one or more steps of one or more methods described or illustrated herein, where appropriate.

In particular embodiments, computer system 900 includes a processor 902, memory 904, storage 906, an input/output (I/O) interface 908, a communication interface 910, and a bus 912. Although this disclosure describes and illustrates a particular computer system having a particular number of particular components in a particular arrangement, this disclosure contemplates any suitable computer system having any suitable number of any suitable components in any suitable arrangement.

In particular embodiments, processor 902 includes hardware for executing instructions, such as those making up a computer program. As an example and not by way of limitation, to execute instructions, processor 902 may retrieve (or fetch) the instructions from an internal register, an internal cache, memory 904, or storage 906; decode and execute them; and then write one or more results to an internal register, an internal cache, memory 904, or storage 906. In particular embodiments, processor 902 may include one or more internal caches for data, instructions, or addresses. This disclosure contemplates processor 902 including any suitable number of any suitable internal caches, where appropriate. As an example and not by way of limitation, processor 902 may include one or more instruction caches, one or more data caches, and one or more translation lookaside buffers (TLBs). Instructions in the instruction caches may be copies of instructions in memory 904 or storage 906, and the instruction caches may speed up retrieval of those instructions by processor 902. Data in the data caches may be copies of data in memory 904 or storage 906 for instructions executing at processor 902 to operate on; the results of previous instructions executed at processor 902 for access by subsequent instructions executing at processor 902 or for writing to memory 904 or storage 906; or other suitable data. The data caches may speed up read or write operations by processor 902. The TLBs may speed up virtual-address translation for processor 902. In particular embodiments, processor 902 may include one or more internal registers for data, instructions, or addresses. This disclosure contemplates processor 902 including any suitable number of any suitable internal registers, where appropriate. Where appropriate, processor 902 may include one or more arithmetic logic units (ALUs); be a multi-core processor; or include one or more processors 902. Although this disclosure describes and illustrates a particular processor, this disclosure contemplates any suitable processor.

In particular embodiments, memory 904 includes main memory for storing instructions for processor 902 to execute or data for processor 902 to operate on. As an example and not by way of limitation, computer system 900 may load instructions from storage 906 or another source (such as, for example, another computer system 900) to memory 904. Processor 902 may then load the instructions from memory 904 to an internal register or internal cache. To execute the instructions, processor 902 may retrieve the instructions from the internal register or internal cache and decode them. During or after execution of the instructions, processor 902 may write one or more results (which may be intermediate or final results) to the internal register or internal cache. Processor 902 may then write one or more of those results to memory 904. In particular embodiments, processor 902 executes only instructions in one or more internal registers or internal caches or in memory 904 (as opposed to storage 906 or elsewhere) and operates only on data in one or more internal registers or internal caches or in memory 904 (as opposed to storage 906 or elsewhere). One or more memory buses (which may each include an address bus and a data bus) may couple processor 902 to memory 904. Bus 912 may include one or more memory buses, as described below. In particular embodiments, one or more memory management units (MMUs) reside between processor 902 and memory 904 and facilitate accesses to memory 904 requested by processor 902. In particular embodiments, memory 904 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 904 may include one or more memories 904, where appropriate. Although this disclosure describes and illustrates particular memory, this disclosure contemplates any suitable memory.

In particular embodiments, storage 906 includes mass storage for data or instructions. As an example and not by way of limitation, storage 906 may include a hard disk drive (HDD), a floppy disk drive, flash memory, an optical disc, a magneto-optical disc, magnetic tape, or a Universal Serial Bus (USB) drive or a combination of two or more of these. Storage 906 may include removable or non-removable (or fixed) media, where appropriate. Storage 906 may be internal or external to computer system 900, where appropriate. In particular embodiments, storage 906 is non-volatile, solid-state memory. In particular embodiments, storage 906 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 906 taking any suitable physical form. Storage 906 may include one or more storage control units facilitating communication between processor 902 and storage 906, where appropriate. Where appropriate, storage 906 may include one or more storages 906. Although this disclosure describes and illustrates particular storage, this disclosure contemplates any suitable storage.

In particular embodiments, I/O interface 908 includes hardware, software, or both, providing one or more interfaces for communication between computer system 900 and one or more I/O devices. Computer system 900 may include one or more of these I/O devices, where appropriate. One or more of these I/O devices may enable communication between a person and computer system 900. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 908 for them. Where appropriate, I/O interface 908 may include one or more device or software drivers enabling processor 902 to drive one or more of these I/O devices. I/O interface 908 may include one or more I/O interfaces 908, where appropriate. The devices may also incorporate additional interfaces, devices, or visualizations via distributed APIs running simultaneous, interrelated queries on the associated databases. Although this disclosure describes and illustrates a particular I/O interface, this disclosure contemplates any suitable I/O interface.

In particular embodiments, communication interface 910 includes hardware, software, or both providing one or more interfaces for communication (such as, for example, packet-based communication) between computer system 900 and one or more other computer systems 900 or one or more networks. As an example and not by way of limitation, communication interface 910 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 910 for it. As an example and not by way of limitation, computer system 900 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 900 may communicate with a wireless PAN (WPAN) (such as, for example, a BLUETOOTH WPAN), a WI-FI network, a WI-MAX network, a mesh radio (RF) network protocol, a cellular telephone network (such as, for example, a Global System for Mobile Communications (GSM) network), or other suitable wireless network or a combination of two or more of these. Computer system 900 may include any suitable communication interface 910 for any of these networks, where appropriate. Communication interface 910 may include one or more communication interfaces 910, where appropriate. Although this disclosure describes and illustrates a particular communication interface, this disclosure contemplates any suitable communication interface.

In particular embodiments, bus 912 includes hardware, software, or both coupling components of computer system 900 to each other. As an example and not by way of limitation, bus 912 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 912 may include one or more buses 912, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate. A computer-readable non-transitory storage medium may be physical or virtual, local or remote.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

What is claimed is:

1. A method for managing a power-distribution system, the method comprising:
by one or more computing devices associated with the power-distribution system, receiving, for each smart meter in a first group of a plurality of smart meters connected to the power-distribution system, first information about energy contributions to the power-distribution system tracked by the smart meter;
by the computing devices, receiving, for each smart meter in a second group of the smart meters, second information about energy consumption from the power-distribution system tracked by the smart meter;
by the computing devices, determining, based on the first information and the second information, a likelihood of an energy shortage during a specified period of time;
by the computing devices, sending instructions to one or more of the smart meters in the second group to limit consumption of energy during the specified period of time; and
by the computing devices, sending instructions to one or more of the smart meters in the first group to increase their energy contributions during the specified period of time.

2. The method of claim 1, wherein the determining is based at least in part on:
an energy contribution capacity of each of the smart meters in the first group;
a history of energy contribution for each of the smart meters in the first group;
a forecast of energy contribution for each of the smart meters in the first group;
a state-of-charge of each of one or more battery banks associated with one or more of the smart meters in the second group; or
a history of energy consumption for each of the smart meters in the second group.

3. The method of claim 1, wherein the instructions related to the contribution or consumption of energy comprise:
an update to a value corresponding to one or more units of energy contribution;
an update to a value corresponding to one or more units of energy consumption;
an update to a minimum limit on energy contribution attributable to a respective one of the smart meters in the first group;
an update to a maximum limit on energy consumption attributable to a respective one of the smart meters in the second group;
an update to a threshold value for a balance of energy credit associated with a respective one of the smart meters in the second group;
an update to a unit of measurement for energy contribution; or
an update to a unit of measurement for energy consumption.

4. The method of claim 1, wherein the information about contribution and consumption of energy is received via a mesh network comprising one or more of the smart meters.

5. The method of claim 1, wherein the instructions sent to a particular smart meter are based at least in part on:
an amount of energy consumption by one or more loads associated with the smart meter;
a location associated with the smart meter;
a service plan associated with the smart meter;
a current time; or
an operational state of the power-distribution system.

6. The method of claim 1, wherein one or more loads associated with a particular smart meter in the second group are connected to a must-run circuit and one or more other loads associated with the smart meter are connected to an interruptible circuit, and wherein the method further comprises:
detecting a power shortage event based on the determining; and
sending instructions to the smart meter causing the smart meter to preferentially supply energy to the loads connected to the must-run circuit.

7. The method of claim 1, wherein the one or more computing devices store a copy of a blockchain transaction ledger comprising a plurality of transactions each associated with one or more of the smart meters.

8. The method of claim 7, further comprising:
by the computing devices, sending instructions to a first smart meter causing the first smart meter to execute a transaction related to a transfer of energy;
by the first smart meter, generating a transaction record associated with the transaction, wherein the first smart meter stores a copy of the blockchain transaction ledger;
by the computing devices, receiving the transaction record from the first smart meter;
by the computing devices, validating the transaction record; and
by the first smart meter, updating the copy of the blockchain transaction ledger stored by the first smart meter to incorporate the transaction record; and
by the computing devices, updating the copy of the blockchain transaction ledger stored by the computing devices to incorporate the transaction record.

9. The method of claim 8, further comprising:
by the first smart meter, broadcasting the transaction record to each of one or more second smart meters, each second smart meter storing a copy of the blockchain transaction ledger;
by each of the second smart meters, validating the transaction record; and
by each of the second smart meters, upon validating the transaction record, updating the respective copy of the blockchain transaction ledger stored on the smart meter to incorporate the transaction record.

10. One or more computer-readable non-transitory storage media embodying software that is operable when executed to:
receive, for each smart meter in a first group of a plurality of smart meters connected to a power-distribution system, first information about energy contributions to the power-distribution system tracked by the smart meter;
receive, for each smart meter in a second group of the smart meters, second information about energy consumption from the power-distribution system tracked by the smart meter;
determine, based on the first information and the second information, a likelihood of an energy shortage during a specified period of time;
send instructions to one or more of the smart meters in the second group to limit consumption of energy during the specified period of time; and
send instructions to one or more of the smart meters in the first group to increase their energy contributions during the specified period of time.

11. The media of claim 10, wherein the determining is based at least in part on:
an energy contribution capacity of each of the smart meters in the first group;
a history of energy contribution for each of the smart meters in the first group;
a forecast of energy contribution for each of the smart meters in the first group;
a state-of-charge of each of one or more battery banks associated with one or more of the smart meters in the second group; or
a history of energy consumption for each of the smart meters in the second group.

12. The media of claim 10, wherein the instructions related to the contribution or consumption of energy comprise:
an update to a value corresponding to one or more units of energy contribution;
an update to a value corresponding to one or more units of energy consumption;
an update to a minimum limit on energy contribution attributable to a respective one of the smart meters in the first group;
an update to a maximum limit on energy consumption attributable to a respective one of the smart meters in the second group;
an update to a threshold value for a balance of energy credit associated with a respective one of the smart meters in the second group;
an update to a unit of measurement for energy contribution; or
an update to a unit of measurement for energy consumption.

13. The media of claim 10, wherein the information about contribution and consumption of energy is received via a mesh network comprising one or more of the smart meters.

14. The media of claim 10, wherein the instructions sent to a particular smart meter are based at least in part on:
an amount of energy consumption by one or more loads associated with the smart meter;
a location associated with the smart meter;
a service plan associated with the smart meter;
a current time; or
an operational state of the power-distribution system.

15. The media of claim 10, wherein one or more loads associated with a particular smart meter in the second group are connected to a must-run circuit and one or more other loads associated with the smart meter are connected to an interruptible circuit, and wherein the software is further operable when executed to:
detect a power shortage event based on the determining; and
send instructions to the smart meter causing the smart meter to preferentially supply energy to the loads connected to the must-run circuit.

16. A system comprising:
one or more processors; and
one or more computer-readable non-transitory storage media coupled to one or more of the processors and comprising instructions operable when executed by one or more of the processors to cause the system to:
receive, for each smart meter in a first group of a plurality of smart meters connected to a power-distribution system, first information about energy contributions to the power-distribution system tracked by the smart meter;
receive, for each smart meter in a second group of the smart meters, second information about energy consumption from the power-distribution system tracked by the smart meter;
determine, based on the first information and the second information, a likelihood of an energy shortage during a specified period of time;
send instructions to one or more of the smart meters in the second group to limit consumption of energy during the specified period of time; and
send instructions to one or more of the smart meters in the first group to increase their energy contributions during the specified period of time.

17. The system of claim 16, wherein the determining is based at least in part on:
an energy contribution capacity of each of the smart meters in the first group;
a history of energy contribution for each of the smart meters in the first group;
a forecast of energy contribution for each of the smart meters in the first group;
a state-of-charge of each of one or more battery banks associated with one or more of the smart meters in the second group; or
a history of energy consumption for each of the smart meters in the second group.

18. The system of claim 16, wherein the instructions related to the contribution or consumption of energy comprise:
an update to a value corresponding to one or more units of energy contribution;
an update to a value corresponding to one or more units of energy consumption;
an update to a minimum limit on energy contribution attributable to a respective one of the smart meters in the first group; or
an update to a maximum limit on energy consumption attributable to a respective one of the smart meters in the second group;
an update to a threshold value for a balance of energy credit associated with a respective one of the smart meters in the second group;
an update to a unit of measurement for energy contribution; or
an update to a unit of measurement for energy consumption.

19. The system of claim 16, wherein the information about contribution and consumption of energy is received via a mesh network comprising one or more of the smart meters.

20. The system of claim 16, wherein the instructions sent to a particular smart meter are based at least in part on:
an amount of energy consumption by one or more loads associated with the smart meter;
a location associated with the smart meter;
a service plan associated with the smart meter;
a current time; or
an operational state of the power-distribution system.
